(19) United States
(12) Patent Application Publication
(10) Pub. No.: US 2024/0190276 A1
(43) Pub. Date: Jun. 13, 2024

(54) ELECTRONIC SYSTEMS FOR ELECTRIC VEHICLES AND RELATED METHODS

(71) Applicant: TAIGA MOTORS INC., Lasalle (CA)

(72) Inventor: Saif Aziz ABSAR, Oakville (CA)

(21) Appl. No.: 18/535,378

(22) Filed: Dec. 11, 2023

Related U.S. Application Data
(60) Provisional application No. 63/431,817, filed on Dec. 12, 2022.

(51) Int. Cl. B60L 53/24; B60L 50/60; B60L 53/16; H02J 7/02; H02J 7/14; H02P 27/06

(52) U.S. Cl. CPC B60L 53/24; B60L 50/60; B60L 53/16; H02J 7/02; H02J 7/14; H02P 27/06; B60L 2210/30; B60L 2210/40; B60L 2220/56; H02J 2207/20

(57) ABSTRACT

Power electronics systems for electric vehicles are provided. These systems may enable propulsion and charging of an electric vehicle, among other functionalities. Related methods are also provided. According to an embodiment, a system includes a battery, a power electronics module to connect to the battery, an electric motor including a plurality of phase windings and a neutral point, and a port to connect to an external device. Each of the plurality of phase windings may connect between the power electronics module and the neutral point. The port may include a first terminal and a second terminal. The system may also include at least one electrical switch to selectively connect the first terminal of the port to the neutral point of the electric motor and to selectively connect the second terminal of the port to the power electronics module.

### CROSS-REFERENCE TO RELATED APPLICATION(S)

This application claims priority from U.S. Provisional Patent Application No. 63/431,817, filed Dec. 12, 2022, which is incorporated by reference in its entirety herein.

### TECHNICAL FIELD

The disclosure relates generally to electric vehicles, and more particularly to electronic systems for electric vehicles.

### BACKGROUND

Electric vehicles typically include one or more electronic systems to perform a wide variety of tasks, including charging a battery of the electric vehicle, controlling power delivery to an electric motor, and powering various vehicle sub-systems, for example. Some electronic systems include a large number of components to enable these tasks, which may increase the complexity and cost of the systems. Further, some electronic systems do not have sufficient fault tolerance that can maintain essential vehicle operations in the event of component failures. Improvement is desired.

### SUMMARY

Aspects of the present disclosure provide electronic systems for electric vehicles that provide additional functionality, use fewer components, and/or improve fault tolerance. Related methods are also provided.

In one aspect, the disclosure describes a system for an electric vehicle including a battery; a power electronics module to connect to the battery; an electric motor comprising a plurality of phase windings and a neutral point, each of the plurality of phase windings connected between the power electronics module and the neutral point; a port to connect to an external device, the port comprising a first terminal and a second terminal; and at least one electrical switch to selectively connect the first terminal of the port to the neutral point of the electric motor and to selectively connect the second terminal of the port to the power electronics module.

In some embodiments, the at least one electrical switch is to connect the first terminal of the port to the neutral point of the electric motor and to connect the second terminal of the port to the power electronics module when the port is connected to the external device.

In some embodiments, the external device comprises a charger providing alternating current (AC) power, and the electric motor and the power electronics module are to rectify and boost the AC power to charge the battery.

In some embodiments, the external device comprises a charger providing direct current (DC) power to charge the battery.

In some embodiments, the external device comprises an external load, and the port is to transfer power from the battery to the external load.

In some embodiments, the power electronics module is to invert direct current (DC) power from the battery to produce alternating current (AC) power for the external load.

In some embodiments, direct current (DC) power from the battery is provided to the external load.

In some embodiments, the at least one electrical switch is to disconnect the first terminal of the port from the neutral point of the electric motor and to disconnect the second terminal of the port from the power electronics module when the port is disconnected from the external device.

In some embodiments, the at least one electrical switch is to connect the neutral point of the electric motor to the power electronics module when the port is disconnected from the external device.

In some embodiments, when the port is disconnected from the external device, the power electronics module is to invert direct current (DC) power from the battery to produce alternating current (AC) power to drive the electric motor.

In some embodiments, the at least one electrical switch is at least one first electrical switch, and the system comprises at least one second electrical switch to selectively connect the battery to the power electronics module to provide the DC power to the power electronics module.

In some embodiments, the at least one electrical switch comprises a first electrical switch to selectively connect the first terminal of the port to the neutral point and a second electrical switch to selectively connect the second terminal the port to the power electronics module.

In some embodiments, the plurality of phase windings comprises three phase windings, the power electronics module comprises three sets of electrical switches connected to three phase windings, respectively, and the power electronics module further comprises a fourth set of electric switches to connect to the second terminal the port.

In some embodiments, the system comprises a first bus and a second bus connecting the battery to the power electronics module, the fourth set of electrical switches comprises a first electrical switch and a second electrical switch connected in series between the first bus and the second bus, and the at least one switch is to connect the second terminal of the port between the first electrical switch and the second electrical switch of the fourth set of electrical switches.

In some embodiments, where the system comprises a voltage converter to connect the power electronics module to the battery.

In some embodiments, the voltage converter is a bi-directional direct current-to-direct current (DC-to-DC) converter.

In some embodiments, the external device comprises a charger providing an alternating current (AC) power, the electric motor and power electronics module are to rectify and boost the AC power to produce DC power, and the voltage converter is to alter a voltage of the DC power to charge the battery.

In some embodiments, the system comprises a low-voltage system, and the bi-directional DC-to-DC converter to reduce the voltage of the DC power to power the low-voltage system.

In some embodiments, the power electronics module comprises a capacitor, and the bi-directional DC-to-DC converter is to pre-charge the capacitor using the battery prior to charging the battery.

In some embodiments, the bi-directional DC-to-DC converter galvanically isolates the battery and the port.

In some embodiments, when the external device comprises an external load and is connected to the charge port, the bi-directional DC-to-DC converter is to receive direct current (DC) power from the battery and alter a voltage of the DC power for the external load.

In some embodiments, the system comprises low-voltage system, and the bi-directional DC-to-DC converter to reduce the voltage of the DC power to power the low-voltage system.

In some embodiments, the port comprises an electromagnetic interference filter.

In some embodiments, the port includes connections for alternating current (AC) supply power and direct current (DC) supply power.

In some embodiments, the system comprises a current sensor connected between the second terminal of the port and the power electronics module.

Embodiments may include combinations of the above features.

In another aspect, the disclosure describes a system for an electric vehicle, the system including an electric motor comprising three phase windings connected to a neutral point; a power electronics module comprising three sets of electrical switches connected to the three phase windings, respectively, and a fourth set of electrical switches to connect to the neutral point; a battery to connect to the power electronics module; and a port to connect to the neutral point and to the fourth set of switches.

In some embodiments, the three sets of electrical switches are to convert direct current (DC) power from the battery to alternating current (AC) power to drive the electric motor.

In some embodiments, when the three sets of electrical switches are converting DC power from the battery to AC power to drive the electric motor, the port is disconnected from the neutral point and disconnected from the fourth set of electrical switches.

In some embodiments, when the three sets of electrical switches are converting DC power from the battery to AC power to drive the electric motor, the fourth set of electrical switches is inactive.

In some embodiments, when the three sets of electrical switches comprise a non-functional set of switches, the remaining two sets of electrical switches are to convert DC power from the battery to AC power to drive the electric motor.

In some embodiments, when the remaining two sets of electrical switches are converting DC power from the battery to AC power to drive the electric motor, the fourth set of switches is connected to the neutral point to provide a current path from the neutral point to the battery.

In some embodiments, the system comprises a first bus and a second bus connecting the battery to the power electronics module, the fourth set of electrical switches comprises a first electrical switch and a second electrical switch connected in series between the first bus and the second bus, and when the remaining two sets of electrical switches are converting DC power from the battery to AC power to drive the electric motor, the neutral point is connected between the first electrical switch and the second electrical switch to provide a current path from the neutral point to first bus and the second bus.

In some embodiments, the system comprises at least one electrical switch to selectively connect the port between the neutral point of the electric motor and the fourth set of electrical switches.

In some embodiments, the port comprises a first terminal to connect to the neutral point of the electric motor and a second terminal to connect to the fourth set of electrical switches.

In some embodiments, the at least one electrical switch is to disconnect the first terminal of the port from the neutral point of the electric motor and to disconnect the second terminal of the port from the fourth set of electrical switches when the port is disconnected from an external device.

In some embodiments, the at least one electrical switch is to connect the neutral point of the electric motor to the fourth set of electrical switches when the port is disconnected from the external device.

In some embodiments, the at least one electrical switch is at least one first electrical switch, the system comprises at least one second electrical switch to selectively connect the battery to the power electronics module.

In some embodiments, the at least one electrical switch is to connect the first terminal of the port to the neutral point of the electric motor and to connect the second terminal of the port to the fourth set of electrical switches when the port is connected to the external device.

In some embodiments, the external device comprises a charger providing alternating current (AC) power, and the electric motor and the power electronics module are to rectify the AC power to charge the battery.

In some embodiments, the external device comprises a charger providing direct current (DC) power, and the electric motor and the power electronics module are to boost a voltage of the DC power to charge the battery.

In some embodiments, the external device comprises an external load, and the port is to transfer power from the battery to the external load.

In some embodiments, the electric motor and the power electronics module are to convert direct current (DC) power from the battery to alternating current (AC) power for the external load.

In some embodiments, direct current (DC) power from the battery is provided to the external load.

In some embodiments, the at least one electrical switch comprises a first electrical switch to selectively connect the first terminal of the port to the neutral point and a second electrical switch to selectively connect the second terminal the port to the fourth set of electrical switches.

In some embodiments, the system comprises a first bus and a second bus connecting the battery to the power electronics module, the fourth set of electrical switches comprises a first electrical switch and a second electrical switch connected in series between the first bus and the second bus, and the at least one switch is to connect the second terminal of the port between the first electrical switch and the second electrical switch of the fourth set of electrical switches.

In some embodiments, the system comprises a voltage converter to connect the power electronics module to the battery.

In some embodiments, the voltage converter is a bi-directional direct current-to-direct current (DC-to-DC) converter.

In some embodiments, the external device comprises a charger providing an alternating current (AC) power, the electric motor and power electronic module to rectify and boost the AC power to provide DC power, and the voltage converter to alter a voltage of the DC power to charge the battery.

In some embodiments, the system comprises a low-voltage system, and the voltage converter is to reduce the voltage of the DC power to power the low-voltage system.

In some embodiments, the power electronics module comprises a capacitor, and the voltage converter is to pre-charge the capacitor using the battery prior to charging the battery.

In some embodiments, the voltage converter galvanically isolates the battery and the port.

In some embodiments, when an external device comprising an external load is connected to the charge port, the voltage converter is to receive direct current (DC) power from the battery and alter a voltage of the DC power for the external load.

In some embodiments, the system comprises a low-voltage system, and the voltage converter is to reduce the voltage of the DC power to power the low-voltage system.

In some embodiments, the port comprises an electromagnetic interference filter.

In some embodiments, the port includes connections for alternating current (AC) supply power and direct current (DC) supply power.

In some embodiments, the system comprises a current sensor connected between the second terminal of the port and the power electronics module.

Embodiments may include combinations of the above features.

In a further aspect, the disclosure describes a system for an electric vehicle, the system comprising a battery having a first voltage; a low-voltage system operating at a second voltage lower than the first voltage; a power electronics module; an electric motor connected to the power electronics module; and a voltage converter. The voltage converter comprises a primary side connected to the power electronics module, a secondary side connected to the battery, and a tertiary side connected to the low-voltage system.

In some embodiments, the voltage converter is a bi-directional direct current-to-direct current (DC-to-DC) converter.

In some embodiments, the bi-directional DC-to-DC converter comprises a transformer.

In some embodiments, the primary side comprises at least one primary side switch and the secondary side comprises at least one secondary side switch.

In some embodiments, the tertiary side comprises a rectifier and regulator.

In some embodiments, the system comprises a port connected to an external device, the port to connect to the electric motor and to the power electronics module.

In some embodiments, the external device comprises a charger providing a first alternative current (AC) power, the electric motor and power electronics module rectify and boost the first AC power to produce a first DC power, the at least one primary side switch is to invert the first DC power and provide a second AC power to the transformer, and the at least one secondary side switch is to rectify the second AC power from the transformer and provide a second DC power to charge the battery.

In some embodiments, a duty cycle of the at least one first side switch and a duty cycle of the at least one secondary side switch is adjusted based on the first voltage of the battery to produce the second DC power to charge the battery.

In some embodiments, the rectifier and regulator of the tertiary side are to rectify the second AC power to provide a third DC power having the second voltage to power the low-voltage system.

In some embodiments, the transformer galvanically isolates the battery and the port.

In some embodiments, the at least one secondary switch is to invert a first DC power from the battery to product a first alternative current (AC) power to the transformer, and the at least one primary side switch is to rectify the first AC power and provide a second DC power to the power electronics module.

In some embodiments, the power electronics module comprises a capacitor, and the second DC power is to charge the capacitor.

In some embodiments, the system comprises at least one switch to connect the battery to the power electronics module, and the second DC power is to pre-charge the capacitor prior to closing the at least one switch.

In some embodiments, the second DC power is to pre-charge the capacitor prior to charging the battery.

In some embodiments, the system comprises at least one switch to connect the battery to the power electronics module, and the second DC power is to power the power electronics module and drive the electric motor when the at least one switch is non-functioning.

In some embodiments, the system comprises a port connected to an external load, the port to connect to the electric motor and to the power electronics module.

In some embodiments, the power electronics module and electric motor are to invert the second DC power to produce a second AC power, and the port is to provide the second AC power to the external load.

In some embodiments, the rectifier and regulator of the tertiary side is to rectify the first AC power to provide a third DC power having the second voltage to power the low-voltage system.

In some embodiments, the system comprises at least one switch to connect the battery to the power electronics module, and when the at least one switch is closed, the battery provides a first DC power to the power electronics module and to the at least one primary side switch, the at least one secondary switch is to invert the first DC power from the battery to product an alternative current (AC) power to the transformer; and the rectifier and regulator of the tertiary side are to rectify the AC power to provide a second DC power having the second voltage to power the low-voltage system.

Embodiments may include combinations of the above features.

In a further aspect, the disclosure describes a method for an electric vehicle comprising an electric motor, a power electronics module, and a port. The method includes connecting a neutral point of the electric motor to the power electronics module to drive the electric motor and, responsive to an external device being connected to the port, connecting the neutral point of the electric motor to a first terminal of the port and connecting the power electronics module to a second terminal of the port.

In some embodiments, the external device comprises a charger providing alternating current (AC) power, the method comprising operating the power electronics module to rectify and boost the AC power to produce direct current (DC) power to charge a battery of the electric vehicle.

In some embodiments, method comprises operating a voltage converter of the electric vehicle to alter a voltage of the DC power to charge the battery.

In some embodiments, the method comprises operating the voltage converter to reduce the voltage of the DC power to power a low-voltage system of the electric vehicle.

In some embodiments, the power electronics module comprises a capacitor, the method comprising operating the voltage converter to pre-charge the capacitor using the battery prior to charging the battery.

In some embodiments, operating the voltage converter to alter the voltage of the DC power to charge the battery comprises galvanically isolating the battery from the port.

In some embodiments, the voltage converter is a bi-directional DC-to-DC converter.

In some embodiments, the method comprises filtering electromagnetic interference using a filter integrated in the port.

In some embodiments, the power electronics module comprises three sets of electrical switches connected to the motor and a fourth set of electrical switches, and connecting the power electronics module to the second terminal of the port comprises connecting the fourth set of switches to the second terminal of the port.

In some embodiments, the fourth set of switches comprises a first switch and a second switch connected in series, and connecting the fourth set of switches to the second terminal of the port comprises connecting the second terminal between the first switch and the second switch.

In some embodiments, operating the power electronics module to rectify and boost the AC power to produce the DC power comprises operating the three sets of electrical switches as at least part of a first leg of a rectifier and operating the fourth set of electrical switches as at least part of a second leg of the rectifier.

In some embodiments, the external device comprises an external load, the method comprises operating the power electronics module to invert direct current (DC) power from a battery of the electric vehicle to produce alternating current (AC) power for the external load.

In some embodiments, method comprises operating a voltage converter of the electric vehicle to alter a voltage of the DC power from the battery.

In some embodiments, the voltage converter is a bi-directional DC-to-DC converter.

In some embodiments, the power electronics module comprises three sets of electrical switches connected to the motor and a fourth set of electrical switches, and connecting the power electronics module to the second terminal of the port comprises connecting the fourth set of switches to the second terminal of the port.

In some embodiments, the fourth set of switches comprises a first switch and a second switch connected in series, and connecting the fourth set of switches to the second terminal of the port comprises connecting the second terminal between the first switch and the second switch.

In some embodiments, operating the power electronics module to invert the DC power from the battery to produce AC power comprises operating the three sets of electrical switches as at least part of a first leg of an inverter and operating the fourth set of electrical switches as at least part of a second leg of the inverter.

In some embodiments, the method comprises, responsive to the external device being disconnected from the port, reconnecting the neutral point of the electric motor to the power electronics module.

In some embodiments, the method comprises operating the power electronics module to invert direct current (DC) power from a battery of the electric vehicle to produce alternating current (AC) power to drive the electric motor when the external device is disconnected from the port.

Embodiments may include combinations of the above features.

In a further aspect, the disclosure describes a method for an electric vehicle comprising an electric motor, a power electronics module, and a battery. The method includes converting direct current (DC) power from the battery to three-phase alternating current (AC) power using three sets of electrical switches in the power electronics module, driving the electric motor with the three-phase AC power and, responsive to one of the three sets of electrical switches being non-functional, converting the DC power from the battery to two-phase AC power using the remaining two sets of electrical switches, driving the electric motor with the two-phase AC power, and balancing current at a neutral point of the electric motor using a fourth set of electrical switches in the power electronics module.

In some embodiments, the fourth set of electrical switches are inactive when converting the DC power from the battery to the three-phase AC power.

In some embodiments, balancing the current at the neutral point of the electric motor comprises operating the fourth set of electrical switches to provide a current path from the neutral point to the battery.

In some embodiments, the electric vehicle comprises a first bus and a second bus connecting the battery to the power electronics module, the fourth set of electrical switches comprises a first electrical switch and a second electrical switch connected in series between the first bus and the second bus, and operating the fourth set of switches to provide a current path from the neutral point to the battery comprises operating the first electrical switch and the second electrical switch to provide a current path from the neutral point to first bus and the second bus.

Embodiments may include combinations of the above features.

In a further aspect, the disclosure describes a method for an electric vehicle comprising a voltage converter, a power electronics module, a battery, and a low-voltage system. The method includes transferring power from the battery to the power electronics module using the voltage converter, transferring power from the power electronics module to the battery using the voltage converter, and transferring power from the power electronics module or the battery to the low-voltage system using the voltage converter.

In some embodiments, the voltage converter comprises a bi-directional direct current-to-direct current (DC-to-DC) converter having a primary side connected to the power electronics module, a secondary side connected to the battery, a tertiary side connected to the low-voltage system, and a transformer connecting the primary side, the secondary side and the tertiary side.

In some embodiments, transferring power from the battery to the power electronics module using the voltage converter comprises inverting, using the secondary side, first DC power from the battery to produce AC power at the transformer, and rectifying, using the primary side, the AC power from the transformer to provide second DC power for the power electronics module.

In some embodiments, the electric vehicle is connected to an external load, and transferring power from the battery to the power electronics module using the voltage converter comprises adjusting a duty cycle of at least one primary side switch of the primary side and a duty cycle of at least one secondary side switch at the secondary side based on a voltage requirement of the external load.

In some embodiments, transferring power from the power electronics module to the battery using the voltage converter comprises inverting, using the primary side, first DC power from the power electronics module to produce AC power at the transformer, and rectifying, using the secondary side, the AC power from the transformer to provide second DC power to charge the battery.

In some embodiments, transferring power from the power electronics module to the battery using the voltage converter comprises galvanically isolating the battery from the power electronics module using the transformer.

In some embodiments, transferring power from the power electronics module to the battery using the voltage converter comprises adjusting a duty cycle of at least one primary side switch of the primary side and a duty cycle of at least one secondary side switch at the secondary side based on a voltage of the battery to produce the second DC power to charge the battery.

In some embodiments, transferring power from the power electronics module or the battery to low-voltage system using the voltage converter comprises inverting, using the primary side, first DC power from the power electronics module to produce AC power at the transformer, and rectifying, using the tertiary side, the AC power from the transformer to provide second DC power to power the low-voltage systems.

In some embodiments, transferring power from the power electronics module or the battery to low-voltage system using the voltage converter comprises inverting, using the secondary side, first DC power from the battery to produce AC power at the transformer, and rectifying, using the tertiary side, the AC power from the transformer to provide second DC power to power the low-voltage systems.

In some embodiments, rectifying, using the tertiary side, the AC power from the transformer to provide the second DC power comprises regulating a voltage of the second DC power using a voltage regulator.

In some embodiments, transferring power from the battery to the power electronics module using the voltage converter comprises pre-charging a capacitor of the power electronics module.

Embodiments may include combinations of the above features.

Further details of these and other aspects of the subject matter of this application will be apparent from the detailed description included below and the drawings.

### DESCRIPTION OF THE DRAWINGS

Reference is now made to the accompanying drawings, in which:

FIG. 1A is a side plan view of an exemplary snowmobile according to some embodiments of the present disclosure;

FIG. 1B is a side plan view of the snowmobile of FIG. 1 showing internal components thereof;

FIG. 1C is a perspective view of part of the snowmobile of FIG. 1 including an electric motor;

FIG. 2 is a block diagram illustrating a system 200 according to some embodiments of the present disclosure;

FIG. 3 is a circuit diagram for the system of FIG. 2, according to an embodiment;

FIG. 4 is a flow diagram illustrating a method of selecting an operating mode from multiple possible operating modes of the system of FIG. 2, according to an embodiment;

FIGS. 5 to 7 are flow diagrams illustrating methods according to embodiments of the present disclosure; and

FIG. 8 is a block diagram illustrating multiple electric vehicles connected to and being charged by a single electric vehicle supply equipment according to an embodiment.

### DETAILED DESCRIPTION

The following disclosure relates to electronics systems for use in electric vehicles, including on-road and off-road vehicles. Non-limiting examples of electric vehicles suitable for the systems and methods described herein include cars, trucks, snowmobiles, motorcycles, watercraft such as boats and personal watercraft (PWC), all-terrain vehicles (ATVs), and utility task vehicles (UTVs) (e.g., side-by-sides). An example of such an electric vehicle is provided below.

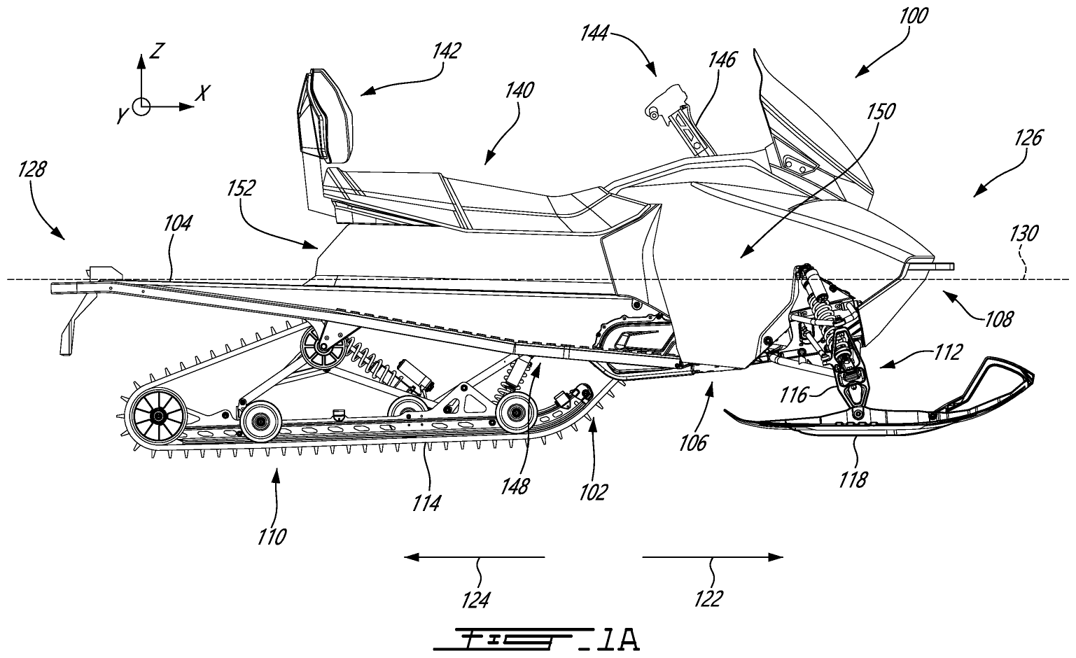

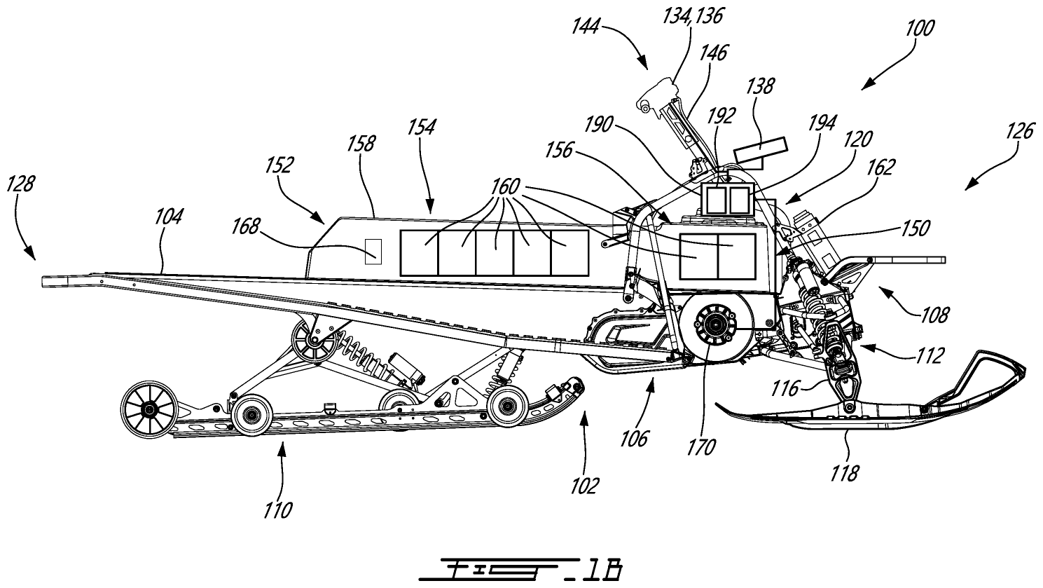

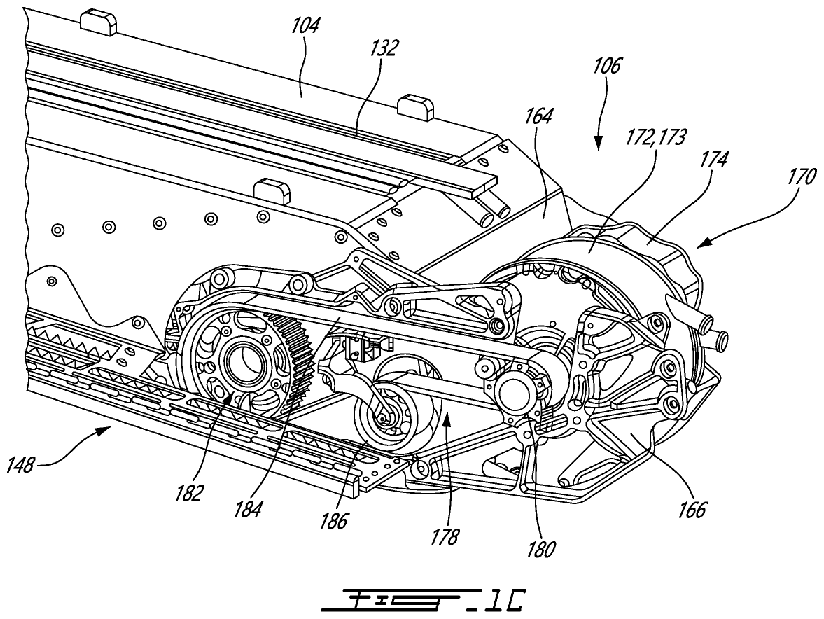

FIG. 1A illustrates a side plan view of a snowmobile 100, according to an embodiment, and FIG. 1B illustrates another side plan view of the snowmobile 100 with several body panels and other components removed so that the interior of the snowmobile 100 may be viewed. The snowmobile 100 includes a frame 102, which may also be referred to as a “chassis” or “body”, that provides a load bearing framework for the snowmobile 100. In the illustrated embodiment, the frame 102 includes a longitudinal tunnel 104, a mid-bay 106 (or “bulkhead”) coupled forward of the tunnel 104, and a front sub-frame 108 (or “front brace”) coupled forward of the mid-bay 106. In some implementations, the mid-bay 106 may form part of the front sub-frame 108.

The snowmobile 100 also includes a rear suspension assembly 110 and a front suspension assembly 112 to provide shock absorption and improve ride quality. The rear suspension assembly 110 may be coupled to the underside of the tunnel 104 to facilitate the transfer of loads between the rear suspension assembly 110 and the tunnel 104. The rear suspension assembly 110 supports a drive track 114 having the form of an endless belt for engaging the ground (e.g., snow) and propelling the snowmobile 100. The rear suspension assembly may include, inter alia, one or more rails and/or idler wheels for engaging with the drive track 114, and one or more control arms and damping elements (e.g., elastic elements such as coil and/or torsion springs forming a shock absorber) connecting the rails to the tunnel 104. The front suspension assembly 112 includes two suspension legs 116 coupled to the front sub-frame 108 and to respective ground engaging front skis 118 (only one suspension leg 116 and ski 118 are visible in FIGS. 1A and 1B). Each of the suspension legs 116 may include two A-frame arms connected to the front sub-frame 108, a damping element (e.g., an elastic element) connected to the front sub-frame 108, and a spindle connecting the A-frame arms and the damping element to a respective one of the skis 118. The suspension legs 116 transfer loads between the skis 118 and the front sub-frame 108. In the illustrated embodiment, the frame 102 also includes an over structure 120 (shown in FIG. 1B), that may include multiple members (e.g., tubular members) interconnecting the tunnel 104, the mid-bay 106 and/or the front sub-frame 108 to provide additional rigidity to the frame 102. However, as discussed elsewhere herein, the over structure 120 may be omitted in some embodiments.

The snowmobile 100 may move along a forward direction of travel 122 and a rearward direction of travel 124 (shown in FIG. 1A). The forward direction of travel 122 is the direction along which the snowmobile 100 travels in most instances when displacing. The rearward direction of travel 124 is the direction along which the snowmobile 100 displaces only occasionally, such as when it is reversing. The snowmobile 100 includes a front end 126 and a rear end 128 defined with respect to the forward direction of travel 122 and the rearward direction of travel 124. For example, the front end 126 is positioned ahead of the rear end 128 relative to the forward direction of travel 122. The snowmobile 100 defines a longitudinal center axis 130 that extends between the front end 126 and the rear end 128. Two opposing lateral sides of the snowmobile 100 are defined parallel to the center axis 130. The positional descriptors “front”, “rear” and terms related thereto are used in the present disclosure to describe the relative position of components of the snowmobile 100. For example, if a first component of the snowmobile 100 is described herein as being in front of, or forward of, a second component, then the first component is closer to the front end 126 than the second component. Similarly, if a first component of the snowmobile 100 is described herein as being behind, or rearward of, a second component, then the first component is closer to the rear end 128 than the second component. The snowmobile 100 also includes a three-axes frame of reference that is displaceable with the snowmobile 100, where the Z-axis is parallel to the vertical direction, the X-axis is parallel to the center axis 130, and the Y-axis is parallel to the lateral direction.

The snowmobile 100 is configured to carry one or more riders, including a driver (sometimes referred to as an “operator”) and optionally one or more passengers. In the illustrated example, the snowmobile 100 includes a straddle seat 140 to support the riders. Optionally, the straddle seat 140 includes a backrest 142. The operator of the snowmobile 100 may steer the snowmobile 100 using a steering mechanism 144 (e.g., handlebars), which are operatively connected to the skis 118 via a steering shaft 146 to control the direction of the skis 118. The tunnel 104 may also include or be coupled to footrests 148 (also referred to as “running boards”), namely left and right footrests each sized for receiving a foot of one or more riders sitting on the straddle seat 140.

Referring to FIG. 1B, the snowmobile 100 is electrically propelled by an electric powertrain 150. The powertrain 150 includes an electric battery 152 (also referred to as a “battery pack”) and an electric motor 170. The battery 152 is electrically connected to the motor 170 to provide electric power to the motor 170. The motor 170, in turn, is drivingly coupled to the drive track 114 to propel the snowmobile 100 across the ground. In other embodiments, the snowmobile 100 may also or instead be propelled by a powertrain including an internal combustion engine. For example, the motor 170 may also or instead be an internal combustion engine.

The battery 152 may include a battery enclosure 158 that houses one or more battery modules 160. The battery enclosure 158 may support the battery modules 160 and protect the battery modules 160 from external impacts, water and/or other hazards or debris. Each battery module 160 may contain one or more battery cells, such as pouch cells, cylindrical cells and/or prismatic cells, for example. In some implementations, the battery cells are rechargeable lithium-ion battery cells. The battery 152 may also include other components to help facilitate and/or improve the operation of the battery 152, including temperature sensors to monitor the temperature of the battery cells, voltage sensors to measure the voltage of one or more battery cells, current sensors to implement column counting to infer the state of charge (SOC) of the battery 42, and/or thermal channels that circulate a thermal fluid to control the temperature of the battery cells. In some implementations, the battery 152 may output electric power at a voltage of between 300 and 800 volts, for example. The snowmobile 100 may also include a charger 162 to convert AC to DC current from an external power source to charge the battery 152. The charger 162 may include, or be connected to, a charging port positioned forward of the straddle seat 140 to connect to a charging cable from an external power source. In some implementations, the charging port is covered by one or more protective flaps (e.g., made of plastic and/or rubber) to protect the charging port from water, snow and other debris. In some embodiments described elsewhere herein, a charger may be implemented by the electric motor 170 rather than being a separate component thereto.

In some implementations, the battery 152 may be generally divided into a tunnel battery portion 154 and a mid-bay battery portion 156. The tunnel battery portion 154 may be positioned above and coupled to the tunnel 104. As illustrated, the straddle seat 140 is positioned above the tunnel battery portion 154 and, optionally, the straddle seat 140 may be supported by the battery enclosure 158 and/or internal structures within the battery 152. The mid-bay battery portion 156 extends into the mid-bay 106 and may be coupled to the mid-bay 106 and/or to the front sub-frame 108. The tunnel battery portion 154 and the mid-bay battery portion 156 may share a single battery enclosure 158, or alternatively separate battery enclosures. In the illustrated example, the tunnel battery portion 154 and the mid-bay battery portion 156 each include multiple battery modules 160 that are arranged in a row and/or stacked within the battery enclosure 158.

It should be noted that other shapes, sizes and configurations of the battery 152 are contemplated. For example, the battery 152 may include multiple batteries that are interconnected via electrical cables. In some embodiments, the battery enclosure 158 may be a structural component of the snowmobile 100 and may form part of the frame 102. For example, the battery enclosure 158 may be coupled to the front sub-frame 108 to transfer loads between the front sub-frame 108 and the tunnel 104. The battery enclosure 158 may be formed from a fiber composite material (e.g., a carbon fiber composite) for additional rigidity. Optionally, in the case that the battery enclosure 158 is a structural component of the snowmobile 100, the over structure 120 may be omitted.

FIG. 1C is a perspective view of the mid-bay 106 of the snowmobile 100. As illustrated, the motor 170 is disposed in a lower portion of the mid-bay 106, below the mid-bay battery portion 156 and forward of a wall 164 defining a front end of the tunnel 104. The motor 170 may be mounted to a transmission plate 166 that is supported between the tunnel 104 and the front sub-frame 108 to help support the motor 170 within the mid-bay 106.

In the illustrated embodiment, the motor 170 is a permanent magnet synchronous motor having a rotor 172 and stator 173. The motor 170 also includes power electronics module 174 (sometimes referred to as an inverter) to convert the direct current (DC) power from the battery 152 to alternating current (AC) power having a desired voltage, current and waveform to drive the motor 170. In some implementations, the power electronics module 174 may include one or more capacitors to reduce the voltage variations between the high and low DC voltage leads, and one or more electric switches (e.g., insulated-gate bipolar transistors (IGBTs)) to generate the AC power. In some implementations, the motor 170 has a maximum output power of between 90 KW and 135 kW. In other implementations, the motor 170 has a maximum output power greater than 135 kW.

In some implementations, the motor 170 may include sensors configured to sense one or more parameters of the motor 170. The sensors may be implemented in the rotor 172, the stator 173 and/or the power electronics module 174. The sensors may include a position sensor (e.g., an encoder) to measure a position and/or rotational speed of the rotor 172, and/or a speed sensor (e.g., a revolution counter) to measure the rotational speed of the rotor 172. Alternatively or additionally, the sensors may include a torque sensor to measure an output torque from the motor 170 and/or a current sensor (e.g., a Hall effect sensor) to measure an output current from the power electronics module 174.

Other embodiments of the motor 170 are also contemplated. For example, the power electronics module 174 may be integrated into the housing or casing of motor 170, as shown in FIG. 1C. However, the power electronics module 174 may also, or instead, be provided externally to the housing or casing of motor 170. In some embodiments, the motor 170 may be a type other than a permanent magnet synchronous motor. For example, the motor 170 may instead be a brushless direct current motor.

The motor 170 may convert the electric power output from the battery 152 into motive power that is transferred to the drive track 114 via a drive transmission 178. The drive transmission 178 engages with a motor drive shaft 180 of the motor 170. The motor drive shaft 180 may extend laterally through an opening in the transmission plate 166. The drive transmission 178 includes a track drive shaft 182 that extends laterally across the tunnel 104. The motor drive shaft 180 and the track drive shaft 182 may extend parallel to each other along transverse axes of the snowmobile 100 and may be spaced apart from each other along the longitudinal axis 130. In the illustrated embodiment, the motor drive shaft 180 is operably coupled to the track drive shaft 182 via a drive belt 184. Sprockets on the motor drive shaft 180 and the track drive shaft 182 may engage with lugs on the drive belt 184. A drive belt idler pulley 186 may also be implemented to maintain tension on the drive belt 184. In other embodiments, another form of linkage such as a drive chain, for example, may operatively connect the motor drive shaft 180 and the track drive shaft 182.

In operation, torque from the motor 170 is transferred from the motor drive shaft 180 to the track drive shaft 182 via the drive belt 184. The track drive shaft 182 includes one or more sprockets (not shown) that engage with lugs on the drive track 114, thereby allowing the track drive shaft 182 to transfer motive power to the drive track 114. It will be understood that the motor 170 may be operated in two directions (i.e., rotate clockwise or counter-clockwise), allowing the snowmobile 100 to travel in the forward direction of travel 122 and in the rearward direction of travel 124. In some implementations, the drive track 114 and the snowmobile 100 may be slowed down via electrical braking (e.g., regenerative braking) implemented by the motor 170 and/or by a mechanical brake (e.g., a disc brake) connected to one of the track drive shaft 182 or the motor drive shaft 180.

The snowmobile 100 may include a heat exchanger 132 that is coupled to, or integrated with, the tunnel 104. The heat exchanger 132 may form part of a thermal management system to control the temperature of the battery 152, the motor 170 and the charger 162, for example. The heat exchanger may include channels to carry a thermal fluid along a portion of the tunnel 104. During operation of the snowmobile 100, the heat exchanger 132 may be exposed to snow and cold air circulating in the tunnel 104 that cools the thermal fluid. The thermal fluid may then be pumped through thermal channels in the battery 152, the motor 170 and/or the charger 162, for example, to cool those components. In some implementations, the thermal management system of the snowmobile 100 may also include a heater 168 (shown in FIG. 1B) to heat the thermal fluid and warm the battery 152. Warming the battery 152 may be useful if the snowmobile 100 has been left for an extended period in a cold environment. In such a case, the temperature of the battery cells in the battery modules 160 may fall to a level where high power is limited from being drawn from the battery 152. Warming the battery 152 may bring the battery cells back into an efficient operating regime. In some implementations, the heater 168 is disposed within the battery enclosure 158.

Referring again to FIG. 1B, one or more controllers 190 (referred to hereinafter in the singular) and an instrument panel 134 are part of a control system for controlling operation of the snowmobile 100. The instrument panel 134 is an example of a user interface that allows an operator of the snowmobile 100 to generate user inputs and/or instructions for the snowmobile 100. The controller 190 is connected to the instrument panel 134 to receive the instructions therefrom and perform operations to implement those instructions. In the illustrated embodiment, the instrument panel 134 is provided on the steering mechanism 144 and the controller 190 is disposed within the interior of the snowmobile 100, but this need not always be the case.

The instrument panel 134 includes an accelerator 136 (also referred to as a “throttle”) to allow an operator to control the power generated by the powertrain 150. For example, the accelerator 136 may include a lever to allow the operator to selectively generate an accelerator signal. The controller 190 is operatively connected to the accelerator 136 and to the motor 170 to receive the accelerator signal and produce a corresponding output from the motor 170. In some implementations, the accelerator signal is mapped to a torque of the motor 170. When the controller 190 receives an accelerator signal from the accelerator 136, the controller 190 maps the accelerator signal to a torque of the motor 170 and controls the power electronics module 174 to produce that torque using feedback from sensors in the motor 50. The mapping of the accelerator signal to an output from the motor 170 may be based on a performance mode of the snowmobile 100 (e.g., whether the snowmobile 100 is in a power-saving mode, a normal mode or a high-performance mode). In some examples, the mapping of the accelerator signal to an output from the motor 170 may be based on current operating conditions of the powertrain 150 (e.g., temperature of the battery 152 and/or motor 170, state of charge of the battery 152, etc.). In still other examples, the mapping of the accelerator signal to an output from the motor 170 may be user configurable, such that a user may customize an accelerator position to motor output mapping.

In addition to the accelerator 36, the instrument panel 34 may include other user input devices (e.g., levers, buttons and/or switches) to control various other functionality of the snowmobile 100. These user input devices may be connected to the controller 190, which executes the instructions received from the user input devices. Non-limiting examples of such user input devices include a brake lever to implement mechanical and/or electrical braking of the snowmobile 100, a reverse option to propel the snowmobile 100 in the rearward direction of travel 124, a device to switch the snowmobile 100 between different vehicle states (e.g., “off”, “neutral” and “drive” states), a device to switch the snowmobile 100 between different performance modes, a device to switch between regenerative braking modes (e.g. “off”, “low” and “high” modes) and a device to activate heating of handgrips of the steering mechanism. The snowmobile 100 also includes a display screen 138 connected to the controller 190. The display screen 138 may be provided forward of the steering mechanism 144, or in any other suitable location depending on the design of the snowmobile 100. The display screen 138 displays information pertaining to the snowmobile 100 to an operator. Non-limiting examples of such information include the current state of the snowmobile 100, the current performance mode of the snowmobile 100, the speed of the snowmobile 100, the state of charge (SOC) of the battery 152, the angular speed of the motor 170, and the power output from the motor 170. The display screen 138 may include a liquid crystal display (LCD) screen, thin-film-transistor (TFT) LCD screen, light-emitting diode (LED) or other suitable display device. In some embodiments, display screen 138 may be touch-sensitive to facilitate operator inputs.

The controller 190 may also control additional functionality of the snowmobile 100. For example, the controller 190 may control a battery management system (BMS) to monitor the SOC of the battery 152 and manage charging and discharging of the battery 152. In another example, the controller 190 may control a thermal management system to manage a temperature of the battery 152, the motor 170 and/or the charger 162 using a thermal fluid cooled by the heat exchanger 132 and/or heated by the heater 168. Temperature sensors in the battery 152 and/or the motor 170 may be connected to the controller 190 to monitor the temperature of these components.

The controller 190 includes one or more data processors 192 (referred hereinafter as “processor 192”) and non-transitory machine-readable memory 194. The memory 194 may store machine-readable instructions which, when executed by the processor 192, cause the processor 192 to perform any computer-implemented method or process described herein. The processor 192 may include, for example, any type of general-purpose microprocessor or microcontroller, a digital signal processing (DSP) processor, an integrated circuit, an application-specific integrated circuit (ASIC), a field programmable gate array (FPGA), a reconfigurable processor, other suitably programmed or programmable logic circuits, or any combination thereof. The memory 194 may include any suitable machine-readable storage medium such as, for example, an electronic, magnetic, optical, electromagnetic, infrared, or semiconductor system, apparatus, or device, or any suitable combination thereof. The memory 194 may be located internally and/or externally to the controller 190.

Although the controller 190 is shown as a single component in FIG. 1B, this is only an example. In some implementations, the controller 190 may include multiple controllers distributed at various locations in the snowmobile 100. For example, the controller 190 may include a vehicle control unit (also referred to as a “body controller”) that is responsible for interpreting the inputs from various other controllers in the snowmobile 100. Non-limiting examples of these other controllers include a motor controller that is part of the power electronics module 174 and a battery management controller that is part of the battery 152. Optionally, separate battery management controllers may be implemented in the each of the battery modules 160 to form a distributed battery management system.

Systems and methods are described and shown in the present disclosure in relation to the snowmobile 100, but the present disclosure may also be applied to other types of vehicles, including other types of off-road and powersport vehicles.

Electric vehicles, including electric powersport vehicles, include power electronics systems that perform a wide variety of tasks to facilitate operation of the vehicle. These tasks include, inter alia, charging a main traction battery, charging a smaller ancillary battery, driving an electric motor, and powering numerous vehicle sub-systems. Some aspects of the present disclosure provide electronics system architectures that may perform these tasks efficiently, reliably, cost effectively, and/or with relatively few components. The electronics systems architectures disclosed herein may also improve functionality as compared to conventional systems.

The term “connected” or “coupled to” may include both direct connection or coupling (in which two elements contact each other) and indirect connection or coupling (in which at least one additional element is located between the two elements). Further, the term “connected” or “coupled to” may include electrical connections or couplings and/or mechanical connections or couplings. The term “substantially” as used herein may be applied to modify any quantitative representation which could permissibly vary without resulting in a change in the basic function to which it is related.

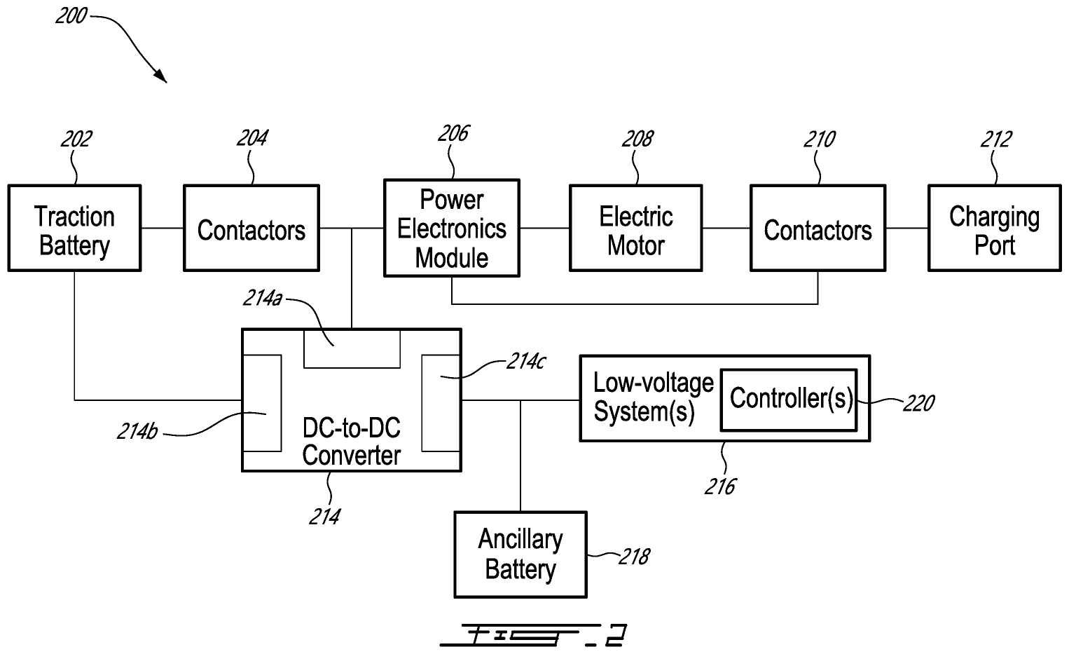

FIG. 2 is a block diagram illustrating a system 200 according to some embodiments of the present disclosure. The system 200 provides an example of a power electronics architecture (and partial powertrain) that may be implemented in an electric vehicle. For example, the system 200 may be implemented in, and/or in conjunction with, the powertrain 150 of the snowmobile 100.

The system 200 includes a traction battery 202, contactors 204, a power electronics module 206, an electric motor 208, contactors 210, a charging port 212, a DC-to-DC converter 214, one or more low-voltage systems 216, an ancillary battery 218, and one or more controllers 220. The traction battery 202 may be the main high-voltage battery pack used to drive the electric motor 208 and propel an electric vehicle. Example implementations of the traction battery 202 are provided above with reference to the battery 152 of FIGS. 1A-1C. As illustrated, the traction battery 202 is connected to the power electronics module 206 via contactors 204. The contactors 204 are examples of high-voltage switches to selectively connect the traction battery 202 to the power electronics module 206 to provide the DC power to the power electronics module 206. In this way, the contactors 204 may control the delivery of DC power from the traction battery 202 to the power electronics module 206. When the electric vehicle is in an off state or in a charging mode, the contactors 204 may be open to disconnect the traction battery 202 from the power electronics module 206. The contactors 204 may then be closed when the electric vehicle is switched an on state and/or a drive state to provide DC power to the power electronics module 206. The power electronics module 206 may invert the DC power to drive the electric motor 208.

The electric motor 208 and the power electronics module 206 are connected to the charging port 212 via the contactors 210, which may include one or more high-voltage electrical switches or jump connections. In this way, the contactors 210 control when the charging port 212 is engaged with the rest of the system 200. The contactors 210 may enable the system 200 to switch between different operating modes, which are discussed in further detail elsewhere herein.

The traction battery 202 is connected to the DC-to-DC converter 214, which is an example of a voltage converter to buck (i.e., reduce) and/or boost (i.e., increase) the voltage of DC power supplied to and/or from the traction battery 202. The DC-to-DC converter 214 is also connected to the power electronics module 206, allowing power to flow between the traction battery 202 and the power electronics module 206 via the DC-to-DC converter 214. The DC-to-DC converter 214 further is connected to the low-voltage systems 216 and to the ancillary battery 218. In this way, the DC-to-DC converter 214 has three sides, which may be referred to as a primary side 214a connected to the power electronics module 206, a secondary side 214b connected to the traction battery 202, and a tertiary side 214c connected to the low-voltage systems 216 and the ancillary battery 218. The DC-to-DC converter 214 may be bi-directional such that current can flow from the primary side 214a to the secondary side 214b, and from the secondary side 214b to the primary side 214a. Current may flow to the tertiary side 214c from the primary side 214a and/or from the secondary side 214b. As discussed in further detail elsewhere herein, the bi-directionality and three sides of the DC-to-DC converter 214 enables the system 200 to perform a wide variety of functions.

The low-voltage systems 216 may include one or more components that use a 12V supply or another low-voltage supply. Similarly, the ancillary battery 218 may be a low-voltage battery (e.g., a 12V battery). The low-voltage systems 216 may be powered by the traction battery 202 via the DC-to-DC converter 214 when the DC-to-DC converter 214 is active. However, when the DC-to-DC converter 214 is inactive (e.g., when an electric vehicle is in an off state and/or when the electric vehicle is transitioning from the off state to an on state), the ancillary battery 218 may be used to power some or all of the low-voltage systems 216.

The low-voltage systems 216 may include any number of different systems in an electric vehicle. Non-limiting examples of low-voltage systems include a thermal management system, a battery management system, and user interfaces. Although the low-voltage systems 216 are shown separately from other components in FIG. 2, the low-voltage systems 216 may include or interact with one or more other components of the system 200. For example, the DC-to-DC converter 214 may form part of a battery management system for an electric vehicle, and the low-voltage output provided by the DC-to-DC converter 214 may be used to power electronics (e.g., electrical switches) in the DC-to-DC converter 214 itself.

In the illustrated example, the low-voltage systems 216 include one or more controllers 220 to control the low-voltage systems 216 and/or other components of the system 200. For example, the controllers 220 may control the contactors 204, the power electronics module 206, the contactors 210, and/or the DC-to-DC converter 214. The controllers 220 may include a body controller and/or a motor controller of an electric vehicle. Example implementations of the controllers 220 are provided above with reference to the controller 190 of FIGS. 1A-1C.

As noted above, the system 200 may operate in and switch between multiple different operating modes. One such operating mode is an inverter mode. In the inverter mode, the charging port 212 is disconnected from the power electronics module 206 and from the electric motor 208 by the contactors 210. As such, the charging port 212 might not interact with the rest of the system 200. This may help ensure that high voltage from the traction battery 202 is not present at the charging port 212. The power electronics module 206 may function as an inverter to drive the electric motor 208 using DC power delivered to the power electronics module 206 from the traction battery 202 via the contactors 204. The low-voltage systems 216 and the ancillary battery 218 may be powered by the traction battery 202 via the DC-to-DC converter 214. For example, power may flow from the secondary side 214b of the DC-to-DC converter 214 to the tertiary side 214c. The primary side 214a of the DC-to-DC converter 214 may be inactive (e.g., no power may flow through the primary side 214a) in the inverter mode.

The system 200 may also or instead operate in an external supply mode or a battery charging mode. In these modes, the contactors 210 may connect the charging port 212 to the power electronics module 206 and to the electric motor 208. The charging port 212 allows the system 200 to connect to an external device, which may be a power source that provides power to the system 200 (e.g., to charge the traction battery 202) or may be an external load that is powered by the system 200 (e.g., using power from the traction battery 202). As such, the charging port 212 is not limited to connecting to charging stations or electric vehicle supply equipment (EVSE). More generally, the charging port 212 may include any electrical port implemented to enable an exchange of power to and/or from the system 200. In some implementations, the charging port 212 may include a single port having multiple different connections for different external devices. Alternatively or additionally, the charging port 212 may include multiple different ports optionally positioned at different locations on an electric vehicle to enable connection to multiple different forms of external devices. For example, the charging port 212 may include AC and/or DC electric vehicle charging connectors (such as J1772 connectors, combined charging system (CCS) connectors, and/or North American charging standard (NACS) connectors), and/or standard 110V and/or 220V outlets.

When the system 200 is in the battery charging mode and the charging port 212 is connected to an external source of power, the power electronics module 206 and the electric motor 208 may function as a voltage converter (e.g., a buck-boost converter) to alter the voltage received at the charging port 212 to charge the traction battery 202. If the source of power provides AC power to the charging port 212 (e.g., during level 1 or level 2 charging), then the power electronics module 206 and the electric motor 208 may also or instead rectify the AC power to produce DC power. The contactors 204 may be open during charging from an AC power source, and traction battery 202 may be charged via the DC-to-DC converter 214 to ensure isolation between the traction battery 202 and the AC power source. For example, the DC power from the power electronics module 206 may flow from the primary side 214a of the DC-to-DC converter 214 to the secondary side 214b to charge the traction battery 202. The DC power from the power electronics module 206 may also or instead flow from the primary side 214a of the DC-to-DC converter 214 to the tertiary side 214c to power the ancillary system 216 and/or to charge the ancillary battery 218.

If the charging port 212 is connected to a DC source of power (e.g., during level 3 or DC fast charging), then the DC power may flow directly from the charging port 212 to the traction battery 202 via the contactors 204, which may be closed. The power electronics module 206 and electronic motor 208 may allow the DC power to passively flow to the traction battery 202 (e.g., without any active changes to the voltage). Alternatively, the power electronics module 206 and electronic motor 208 may actively boost the voltage of the DC power to match that of the traction battery 202 if, for example, the DC power source does not provide a voltage sufficient to charge the traction battery 202. The DC-to-DC converter 214 might not be utilized for charging the traction battery 202 during DC charging, but may be utilized to power the low-voltage systems 216 and/or to charge the ancillary battery 218 (i.e., power flow from the primary side 214a to the tertiary side 214c).

When the charging port 212 is connected to an external load, the system 200 may enter the external supply mode. In this mode, the power electronics module 206 and the electric motor 208 may function as a voltage converter (e.g., a buck-boost converter) to alter a voltage output to the external load from the traction battery 202. In some cases, the external load connected to the charging port 212 may be one or more devices requiring a single-phase AC power supply (e.g., a 110V or 220V supply at 50 Hz or 60 Hz). Non-limiting examples of such devices include power tools, lights, and cooking appliances. The external device connected to the charging port 212 need not be limited to a single appliance and might instead be a home or grid that is connected to the charging port 212. To power the external device, DC power from the traction battery 202 may flow from the secondary side 214b to the primary side 214a of the DC-to-DC converter 214, which may alter the voltage of the DC power. The power electronics module 204 and electric motor 206 may then covert (e.g., invert and/or buck or boost) DC power from the primary side 214A of the DC-to-DC converter 214 to AC power having a voltage and/or frequency suitable to power the external device. This situation may generally be referred to as “vehicle-to-load” power transfer.

In some cases, the external load connected to the charging port 212 may include a device requiring a DC power supply. For example, the external load may be another vehicle having a high-voltage traction battery. The other vehicle may be connected to the charging port 212 to charge from the traction battery 202. In such a case, DC power from the traction battery 202 may flow from the secondary side 214b to the primary side 214a of the DC-to-DC converter 214. The DC-to-DC converter 214 may alter the voltage from the traction battery 202 to match that of the traction battery in the other vehicle. The power electronics module 206 and the electric motor 208 may be in a passive configuration to allow the DC power from the DC-to-DC converter 214 to flow to the charging port 212. This situation may be referred to as “vehicle-to-vehicle” power transfer.

The ability of the system 200 to power/charge external loads may be useful when implemented in an off-road vehicle, as the traction battery 202 may serve as a powerpack that can be transported to remote locations by the off-road vehicle. The traction battery 202 may then power tools, homes and/or other electric vehicles in locations where power is limited.

As outlined above, the system 200 allows the power electronics module 206 and electric motor 208 to operate as both a charger for the battery 202 (in combination with the DC-to-DC converter 214), a voltage converter for powering external loads, and as a tractive unit to propel an electric vehicle. In this way, the system 200 provides an integrated charger-inverter drivetrain. Advantageously, this allows the system 200 to operate without a dedicated charger, thereby reducing the number of components in the system 200.

The system 200 may also operate in additional modes that provide advantages and efficiencies as compared to conventional power electronics architectures. In some implementations, the system 200 may operate in a pre-charging mode where the DC-to-DC converter 214 enables pre-charging a high-voltage bus connecting the contactors 204 and the power electronics module 206. For example, DC power from the traction battery 202 may flow from the secondary side 214b to the primary side 214a of the DC-to-DC converter 214 to charge the high-voltage bus to a particular voltage level. This pre-charging may be performed before closing the contactors 204 to avoid an abrupt surge of current from the traction battery 202 to the power electronics module 206 that could damage components of the system 200. For example, the contactors 204 could be welded shut by such a surge of current, thereby preventing the contractors 204 from being opened to turn-off an electric vehicle. Pre-charging the high-voltage bus connecting the contactors 204 and the power electronics module 206 may also, or instead, be performed before charging the traction battery 202 and/or before supplying power to an external device. Some conventional power electronics systems for electric vehicles include a dedicated pre-charger to charge a high-voltage bus, which is a component that may be prone to failure. Utilizing the DC-to-DC converter 214 to perform pre-charging may reduce the number of components needed and remove a mode of failure as compared to conventional power electronics systems utilizing a dedicated pre-charger.

In some embodiments, the system 200 may operate in one or mode fault tolerant modes when failures of certain components occur. These fault tolerant modes may help ensure that the failures of certain components will not render the system 200 and an electric vehicle inoperable. Fault tolerance may be beneficial in off-road vehicles that are driven in remote locations where assistance may be more difficult to obtain. As discussed in further detail elsewhere herein, the power electronics module 206 may include an extra set of electrical switches to help ensure that the electric motor 208 can still be driven in the event of one set of switches in the power electronics module 206 failing. Further, the DC-to-DC converter 214 may be used to power the power electronics module 206 and drive the electric motor 208 in the event that the contactors 204 cannot be closed, which may occur due to an issue with the contactors 204 themselves or an insulation fault in the system 200 that prevents the contractors 204 from being closed for safety reasons. In such an event, the DC-to-DC converter 214 may power the power electronics module 206 through power flow from the secondary side 214b to the primary side 214a while providing galvanic isolation.

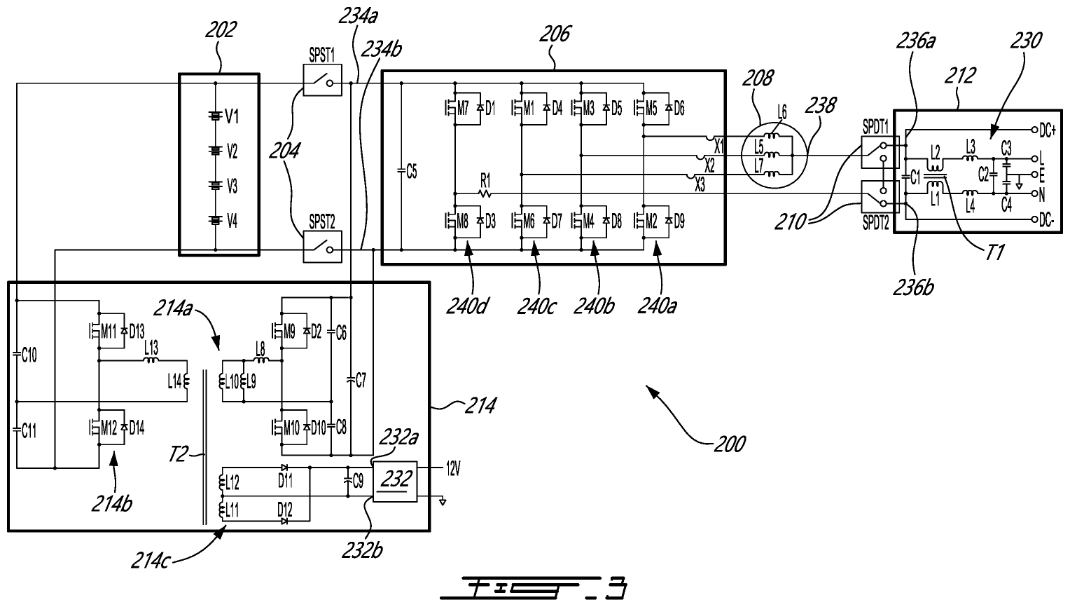

Referring now to FIG. 3, shown is a circuit diagram for the system 200 of FIG. 2, according to an embodiment. FIG. 3 provides an example circuit implementation of the system 200, however other implementations are also contemplated.

In the example of FIG. 3, the traction battery 202 includes four battery modules V1, V2, V3, V4 connected in series, and the contactors 204 include two single pole, single throw (SPST) switches SPST1, SPST2. The positive terminal of the traction battery 202 is connected to the switch SPST1, which may form part of a first high-voltage bus 234a to connect the positive terminal of the traction battery 202 to the power electronics module 206. The negative terminal of the traction battery 202 is connected to the switch SPST2, which may form part of a second high-voltage bus 234b to connect the negative terminal of the traction battery 202 to the power electronics module 206.

It should be noted that the configuration of the traction battery 202 and contactors 204 in FIG. 3 is provided by way of example. In other implementations, different numbers and configurations of battery modules may be used in the traction battery 202, and different numbers and types of switches may be used in the contactors 204.

The power electronics module 206 shown in FIG. 3 includes a capacitor C5 and four sets of electrical switches 240a, 240b, 240c, 240d, which may all be connected in parallel across the high-voltage buses 234a, 234b. Each set of electrical switches 240a, 240b, 240c, 240d may include two electrical switches arranged in series between the high-voltage buses 234a, 234b, with a diode connected anti-parallel across each of the electrical switches. The diodes may be body diodes that are inherent to the electrical switches. In the illustrated example, the set of electrical switches 240a includes switches M2, M5 and body diodes D6, D9; the set of electrical switches 240b includes switches M3, M4 and body diodes D5, D8; the set of electrical switches 240c includes switches M1, M6 and body diodes D4, D7; and the set of electrical switches 240d includes switches M7, M8 and body diodes D1, D3. A discussed in further detail elsewhere herein, this four-leg topology for the power electronics module 206 may enable two-phase operation in the case that there is a fault at any of the three motor phases (e.g., a fault in any of the sets of electrical switches 240a, 240b, 240c).

In some implementations, the switches M1-M8 are silicon carbide metal-oxide-semiconductor field-effect transistors (MOSFETs) that may exhibit relatively short rise and fall times and high blocking voltages. Other implementations of the power electronics module 206 are also contemplated. For example, the switches M1-M8 may include insulated gate bipolar transistors (IGBTs) and/or may include other semiconductor platforms such as silicon or gallium nitride.

The electric motor 208 may be a three-phase permanent magnet synchronous motor including three phase windings L5, L6, L7. The phase windings L5, L6, L7 (also referred to as “motor windings”) may be provided in the stator of the electric motor 208 and may each connect to a neutral point 238 of the electric motor 208. Each of the phase windings L5, L6, L7 may also connect to the power electronics module 206. The phase winding L6 may be connected to the set of electrical switches 240a, between the switches M2, M5. The phase winding L5 may be connected to the set of electrical switches 240b, between the switches M3, M4. The phase winding L7 may be connected to the set of electrical switches 240c, between the switches M1, M6. The electrical current through each of the phase windings L6, L5, L7 may be measured by a respective current sensor X1, X2, X3 in the power electronics module 206 to help facilitate motor control and/or battery charging. The current sensors X1, X2, X3 may include non-invasive means of current measurement such as Hall-effect current sensors, for example.

The contactors 210 may include two single pole, double throw (SPDT) switches SPDT1, SPDT2. In other embodiments, three SPST switches may be implemented in place of the switches SPDT1, SPDT2. The switch SPDT1 may be used to selectively connect a terminal 236a of the charging port 212 to the neutral point 238 and the switch SPDT2 may be used to selectively connect another terminal 236b of the charging port 212 to the power electronics module 206. For example, the common side of the switch SPDT1 may be connected to the neutral point 238 of the electric motor 208, the normally closed side of the switch SPDT1 may be connected to the terminal 236a of the charging port 212, and the normally open side of the switch SPDT1 may be connected to the normally open side of the switch SPDT2. The normally closed side of the switch SPDT2 may be connected to the terminal 236b of the charging port 212. The common side of the switch SPDT2 may be connected to the set of electrical switches 240d, and in particular may be connected between the switches M7, M8. In the illustrated example, a resistor R1 is implemented between the common side of the switch SPDT2 and the set of electrical switches 240d as a shunt based high-frequency current sensor. In operation, the contactors 210 may selectively connect the terminal 236a of the charging port 212 to the neutral point 238 of the electric motor 208 and/or may selectively connect the terminal 236b of the charging port 212 to the power electronics module 206 (e.g., to the set of electrical switches 240d). The contactors 210 may also selectively connect the set of electrical switches 240d to the neutral point 238.

Other embodiments of the contactors 210 are also contemplated. For example, the contactors 210 may include a jump connector integrated with a charging cap of the charging port 212 such that, when the charging cap is closed, the jump connector automatically connects the neutral point 238 of the electric motor 208 to the power electronics module 206. When the charging cap is opened (e.g., when an external device is connected to the charging port 212), the jump connector automatically disconnects the neutral point 238 of the electric motor 208 from the power electronics module 206. In this way, the position of the charging cap may switch the system 200 between various operational modes, as discussed in further detail elsewhere herein.

The charging port 212 of FIG. 3 may include five connections (also referred to as “terminals”) to connect the system 200 to one or more external devices, such as to an external power supply and/or to an external load, for example. The five connections include may two connections for receiving/supplying DC power, namely a positive DC connection DC+ and a negative DC connection DC−. The five connections may also include three connections for receiving/supplying AC power, namely a live (or hot) connection L, a neutral connection N, and a ground (or earth) connection E. In some implementations, the connections DC+, DC−, L, E, N may be provided by a CCS connector or other type of standardized electrical vehicle charging connector. In some implementations, the charging port 212 may include more or fewer than five connections. In some implementations, the charging port 212 may include other connections such as one or more data connections to allow an external device to communicate with a controller (e.g., the controllers 220) of the system 200 and/or of an electric vehicle.

As illustrated, the positive DC connector DC+ is connected directly to the terminal 236a of the charging port 212 and the negative DC connector DC− is connected directly to the terminal 236b. The charging port 212 may include an integrated electromagnetic interference (EMI) filter 230 connecting the live connection L and neutral connection N to the terminals 236a, 236b. The EMI filter 230 may remove noise and unwanted signals from the electrical power propagating through the charging port 212 to protect the system 200 and/or to protect an external device connected to the charging port 212. In some implementations, the EMI filter 230 may be an AC power line filter, for example. The EMI filter may include several capacitors C1, C2, C3, C4, several inductors L1, L2, L3, L4, and a common mode choke T1. The capacitor C1 may be connected between the terminals 236a, 236b of the charging port 212. The capacitors C3, C4 may be connected in series between the live connection L and the neutral connection N. The ground connection E may be connected between the capacitors C3, C4. The ground connection E may connect to earth from an AC power source and may also connect to the chassis of an electric vehicle. The capacitor C2 may also be connected between the live and neutral connections L, N, in parallel with the capacitors C3, C4. The inductors L2, L3 may be connected in series between the live connection L and the first terminal 236a of the charging port 212. The inductors L1, L4 may be connected in series between the neutral connection L and the second terminal 236b of the charging port 212. The inductors L1, L2 may form the windings of the common mode choke T1, which may be implemented in parallel with the capacitor C1, between the terminals 236a, 236b.

The size, type, and other characteristics of the capacitors C1-C4, inductors L1-L4, and common mode choke T1 are not limited herein and may vary based on the implementation of the system 200. It should also be noted that the EMI filter 230 shown in FIG. 3 is provided only by way of example. Other EMI filter configurations are also contemplated. In some embodiments, the charging port 212 might not include an EMI filter at all.

FIG. 3 shows an example of the DC-to-DC converter 214 in circuit form, including the primary side 214a, the secondary side 214b and the tertiary side 214c. The primary side 214a, the secondary side 214b, and the tertiary side 214c may each be connected via a transformer (or transformer core) T2 of the DC-to-DC converter 214. In some implementations, the DC-to-DC converter 214 may be or include a half-bridge LLC converter. However, other implementations of the DC-to-DC converter 214 are also contemplated.

The primary side 214a may be connected to the first high-voltage bus 234a and the second high-voltage bus 234b of the system 200, at a position between the contactors 204 and the power electronics module 206. The primary side 214a may include capacitors C6, C7, C8, inductors L8, L9, L10, electric switches M9, M10 and body diodes D2, D10. The capacitor C7 may be connected between the high-voltage bus 234a and the high-voltage bus 234b. In the illustrated example, the capacitor C7 is an electrolytic capacitor. The capacitors C6, C8 may also be connected in series between the high-voltage buses 234a, 234b, in parallel with the capacitor C7. Further, the electrical switches M9, M10 may be connected in series between the high-voltage buses 234a, 234b, also in parallel with the capacitor C7 and the capacitors C6, C8. The body diodes D2, D10 may be inherent elements of the electrical switches M9, M10 that are connected anti-parallel across the electrical switches M9, M10, respectively. As shown, the inductors L8, L9, L10 may form the primary transformer winding of the transformer T2. The inductor L8 may be the leakage inductance component of the primary side winding and the inductor L9 may be the magnetization inductance component of the primary side winding. The inductor L8 may be connected between the electrical switches M9, M10 and the inductors L9, L10 may be connected between the capacitors C6, C8.

As discussed in further detail elsewhere herein, the primary side 214a may function as an inverter to convert DC power from the high-voltage buses 234a, 234b into AC power that may be conveyed through the transformer T2. Additionally, the primary side 214a may function as a rectifier to convert AC power conveyed through the transformer T2 into DC power for the high-voltage buses 234a, 234b.

The secondary side 214b may be connected to the positive and negative terminals of the traction battery 202. The secondary side 214b may include capacitors C10, C11, inductors L13, L14, electrical switches M11, M12, and body diodes D13, D14. The capacitors C10, C11 may be connected in series between the positive and negative terminals of the traction battery 202. The electrical switches M11, M12 may also be connected in series between the positive and negative terminals of the traction battery 202, in parallel with capacitors C10, C11. The body diodes D13, D14 may be inherent elements of the electrical switches M11, M12 that are connected anti-parallel across the electrical switches M11, M12, respectively. The inductors L13, L14 may form the secondary transformer winding of the transformer T2, where the inductor L13 may be the leakage inductance component of the secondary side winding. The inductor L13 may be connected between the electrical switches M12, M12, and the inductor L14 may be connected between the capacitors C10, C11.

Similar to the primary side 214a, the secondary side 214b may function as an inverter to convert DC power from the traction battery 202 into AC power that may be conveyed through the transformer T2. The secondary side 214 may also or instead function as a rectifier to convert AC power conveyed through the transformer T2 into DC power to charge the traction battery 202. As power can be conveyed from the primary side 214a to the secondary side 214b, and from the secondary side 214b to the primary side 214a, the DC-to-DC converter 214 may be a bi-directional DC-to-DC converter.

In some embodiments, electrical switches may be connected between the traction battery 202 and the secondary side 214b of the DC-to-DC converter to selectively connect/disconnect the traction battery 202 from the secondary side 214b.

The tertiary side 214c of the DC-to-DC converter 214 may include two inductors L11, L12 that form the tertiary windings of the transformer T2. In some implementations, the two inductors L11, L12 may form a center tapped transformer. The tertiary side 214c may also include a DC regulator 232 (also referred to as a DC post regulator) having a first input 232a and a second input 232b, a capacitor C9 (illustratively an electrolytic capacitor), and two diodes D11, D12. The capacitor C9 may be connected between the first input 232a and the second input 232b of the DC regulator 232. The inductor L12 may be connected to the first input 232a via the diode D11, and the inductor L11 may also be connected to the first input 232a via the diode D12. The second input 232b may be connected between the inductors L11, L12.

The tertiary side 214c may function as a passive (e.g., non-switching) rectifier to convert AC power from the transformer T2 to DC power. The DC regulator 232 may regulate the DC output from the tertiary side 214c to a defined voltage, which is 12V in the illustrated example. The 12V output may be provided to the low-voltage systems 216 and/or the ancillary battery 218. In some implementations, the DC regulator 232 is a buck-boost converter that can convert a DC power between 6 and 18V received across the first input 232a and second input 232b to 12V.

In the illustrated example, the electrical switches M9-M12 are shown as MOSFETs, however other types of transistors may also or instead be used. The electrical switches M9-M12 may be build on a silicon platform or another semiconductor platform. The size, type, and other characteristics of the capacitors C6-C11, inductors L8-L14, and transformer T2 are not limited herein and may vary based on the implementation of DC-to-DC converter 214.

As discussed above, the system 200 may operate in any one of multiple possible modes depending on the state of the system 200 and/or on commands from an operator. Example operational modes of the system 200 will now be described.

The inverter mode of the system 200 may be used to drive the electric motor 208 and propel an electric vehicle in response to accelerator commands from an operator, for example. In some implementations, the inverter mode may correspond to a drive state of the electric vehicle. The inverter mode may only be operable by the system 200 when the charging port 212 is disconnected from any external devices.

The inverter mode may be configured by closing the switches SPST1, SPST2 to connect the power electronics module 206 to the traction battery 202 via the high-voltage buses 234a, 234b. The sets of switches 240a, 240b, 240c in the power electronics module 206 may then invert DC power from the traction battery 202 to produce AC power to drive the electric motor 208. The set of switches 240d may be inactive in the inverter mode, such that the switches M7, M8 are not actively converting DC power from the traction battery 202 to AC power to drive the electric motor 208. In some implementations, the switches M7, M8 are open in the inverter mode.

In the inverter mode, the charging port 212 may be disconnected from the remainder of the system 200 using the contactors 210. For example, the switch SPDT1 may disconnect the terminal 236a of the charging port 212 from the neutral point 238 of the electric motor 208 and the switch SPDT2 may disconnect the terminal 236b of the charging port 212 from the set of switches 240d in the power electronics module 206. Further, the switches SPDT1, SPDT2 may connect the neutral point 238 of the electric motor 208 to the power electronics module 206. Alternatively, the neutral point 238 may be floating (i.e., not connected to anything other than the phase windings L5, L6, L7). The phase windings L5, L6, L7 may provide a balanced current at the neutral point 238.

In the inverter mode, the DC-to-DC converter 214 may be operating to supply power to the low-voltage systems 216. For example, power may flow from the secondary side 214b to the tertiary side 214c to produce a 12V supply for the low-voltage systems 216.

The inverter mode may correspond to a mode where no component failures are detected in the system 200, allowing the system 200 to operate in a normal fashion. However, the system 200 may also include additional operating modes that allow operation in the event of certain faults. In some embodiments, the system 200 may operate in an inverter fault tolerant mode that enables operation of the system 200 when one or more components of the power electronics module 206 are non-functional. For example, in some cases, one of the sets of switches 240a, 240b, 240c may be non-functional due to one or more of the switches M1-M6 failing. The failure of an electrical switch such as a MOSFET might be a rare occurrence, but is still a possibility. When one of the sets of the switches 240a, 240b, 240c is non-functional, the corresponding phase (also referred to as “leg”) of the electric motor 208 may also be non-functional. As such, only two of the phase windings L5, L6, L7 may be operational to drive the electric motor 208. In the inverter fault tolerant mode, when one set of the electrical switches 240a, 240b, 240c is non-functional, the system 200 may use the remaining two sets of electrical switches to convert DC power from the traction battery 202 to AC power to drive the electric motor 208. This may be referred to herein as two-phase operation of the electric motor 208.

To facilitate two-phase operation in the inverter fault tolerant mode, the set of electrical switches 240d is connected to the neutral point 238 of the electric motor 208 via the contactors 210. For example, the switches SPDT1, SPDT2 may each be switched from the configuration shown in FIG. 3 to connect the mid-point of the set of electrical switches 240d to the neutral point 238. The set of electrical switches 240d may then provide a path for imbalanced current at the neutral point 238 back to the traction battery 202. This imbalanced current may occur as a result of the two-phase operation of the electric motor 208, where there is no active third phase to balance the current. The switches M7, M8 may operate (i.e., switch at an appropriate duty cycle) to provide a current path from the neutral point 238 to one of the high-voltage buses 234a, 234b based of the phase of the current at the neutral point 238. In this way, the set of switches 240d may maintain neutral operation of the neutral point 238 to help ensure that the electric motor 208 is operable.

Although operating the system 200 in the inverter fault tolerant mode may provide limited performance capabilities as compared to the normal inverter mode, the inverter fault tolerant mode may still allow the electric motor 208 to be driven and propel an electric vehicle. This may allow a user to drive the electric vehicle to a location where the necessary repairs to the power electronics module 206 may be performed. In contrast, conventional electric vehicles that have a power electronics module with only three sets of electric switches may be inoperable in the event that one of the sets of switches fails. For example, in such an electric vehicle, current imbalance at the neutral point of an electric motor during two-phase operation may render the electric motor inoperable.

The system 200 may also operate in another fault tolerant mode, referred to as an insulation fault tolerant mode, when an insulation failure is detected between the traction battery 202 and other components of an electric vehicle (e.g., the chassis). Such an insulation failure may be detected by an insulation monitoring device (IMD), for example. When an insulation failure is detected, the contactors 204 may be opened to disconnect the traction battery 202 for safety reasons. The insulation fault tolerant mode may still enable the system 200 to drive the electric motor 208 when the contactors 204 are open by providing power to the power electronics module 206 from the traction battery 202 via the DC-to-DC converter 214. For example, power may flow from the secondary side 214b to the primary side 214a to power the power electronics module 206. As such, the transformer T2 of the DC-to-DC converter 214 may provide galvanic isolation between the traction battery 202 and the high-voltage buses 234a, 234b when operating in the insulation fault tolerant mode for improved safety.

Due to power limitations of the DC-to-DC converter 214, the insulation fault tolerant mode of the system 200 may provide limited performance capabilities as compared to the normal inverter mode. However, the insulation fault tolerant mode may still allow the electric motor 208 to be driven to propel an electric vehicle, which may allow an operator to drive the electric vehicle to a location where repairs can be performed.

In the inverter fault tolerant mode and the insulation fault tolerance mode, similar to the inverter mode, the DC-to-DC converter 214 may be operating to supply power to the low-voltage systems 216 from the secondary side 214b via the tertiary side 214c.

The system 200 may operate in one of the inverter mode, the inverter fault tolerant mode, or the insulation fault tolerance mode when the charging port 212 is disconnected from an external device. In some implementations, when an external device is connected to the charging port 212, the system 200 may be restricted from operation in the inverter mode, the inverter fault tolerant mode, or the insulation fault tolerant mode. The system 200 may instead operate in a battery charging mode or an external supply mode. Optionally, operation of the electric motor 208 may be disabled (e.g., the electric motor 208 may be in a logic neutral state) when an external device is connected to the charging port 212, where accelerator commands from a user are disabled or ignored.

In some implementations, the battery charging mode and the external supply mode may only be entered upon an external device being connected to the charging port 212. For example, when the charging port 212 is connected to the external device, the contactors 210 may connect the terminal 236a of the charging port 212 to the neutral point 238 of the electric motor 208 and connect the terminal 236b of the charging port 212 to the set of switches 240d of the power electronics module 206. Connecting the charging port 212 to the motor 208 and the power electronics module 206 in this manner may be performed automatically in response to an external device being connected to the charging port 212. For example, logic executed by a controller (e.g., the controllers 220) and/or an analog circuit may operate the contactors 210 to configure the system 200 in the battery charging mode or the external supply mode when an external device is detected at the charging port 212.

Similarly, in some implementations, disconnecting the charging port 212 from the motor 208 and the power electronics module 206 for the inverter mode and fault tolerant modes may also be performed automatically in response to an external device being disconnected from the charging port 212. Logic executed by a controller and/or an analog circuit may operate the contactors 210 to enable the inverter modes and fault tolerant modes when no external device is detected at the charging port 212.

Referring to the battery charging mode for the system 200, the charging port 212 may be connected to an external charger providing AC power or DC power. When the charger provides AC power, the electric motor 208 and power electronics module 206 may act to rectify and boost the AC power to produce DC power across the high-voltage buses 234a, 234b. For example, the motor 208 and the power electronics module 206 may function as a totem-pole bridgeless power factor correction (PFC) circuit. The three phase windings L5, L6, L7 may be used in parallel as a single boost inductor, and the three sets of switches 240a, 240b, 240c may be synchronized to function as a single switch for one leg of the totem-pole bridgeless PFC. The set of switches 240d may function as the other leg of the totem-pole bridgeless PFC. In this way, the electric motor 208 and the power electronics module 206 may form the PFC stage of an integrated charger in the system 200 to provide DC power across the high-voltage buses 234a, 234b. In some implementations, the PFC stage may boost the root mean square (RMS) voltage of the incoming AC power by between 1.4 times and 10 times.

When the external charger provides AC power to the charging port 212, the switches SPST1, SPST2 may be open to galvanically isolate the traction battery 202 from the charger 212. Power flow may be conducted through the DC-to-DC converter 214 to charge the traction battery 202. For example, DC power across the high-voltage buses 234a, 234b may be transferred from the primary side 214a to the secondary side 214b of the DC-to-DC converter 214. The voltage across the high-voltage buses 234a, 234b may be altered (e.g., bucked or boosted) by the DC-to-DC converter 214 based on an SOC and/or a voltage of the traction battery 202 to charge the traction battery 202 according to a certain charging methodology (e.g., constant current or constant voltage charging). For example, the duty cycles of the switches M9, M10 at the primary side 214a and/or the switches M11, M12 at the secondary side 214b may be controlled based on the voltage of the traction battery 202. Power may also be transferred from the primary side 214a to the tertiary side 214c to power the low-voltage systems 216.

As outlined above, the configuration of the system 200 enables the contactors 210 to switch the function of the power electronics module 206 from a motor inverter for propelling an electric vehicle to a boost converter for charging the electric vehicle. As such, the power electronics module 206 and the electric motor 208 may play at least two important roles in the system 200 that are conventionally performed by different components. This may reduce the weight, cost and complexity of the system 200 as compared to conventional power electronics architectures for electric vehicles.

When the external charger provides DC power, the electric motor 208 and power electronics module 206 may be passive components that enable the DC power to flow directly from the charging port to the high-voltage buses 234a, 234b. For example, the switches M1, M3, M5, M8 may be closed and the switches M2, M4, M6, M7 may be open. Alternatively, the electric motor 208 and power electronics module 206 may function as a boost converter to boost the DC voltage according to a voltage/SOC of the traction battery 202 and a charging methodology, for example. The switches SPST1, SPST2 may also be closed to enable power to flow directly to the traction battery 202 to charge the battery.

Although current is flowing through the phase windings L5, L6, L7 of the electric motor 208 in the battery charging mode, the electric motor 208 should not move as the currents flowing through the phase windings L5, L6, L7 are all in phase and equal in magnitude. Therefore, there is no rotating magnetic field and zero torque will be produced in the electric motor 208. In the case that the electric motor 208 does move in the battery charging mode for any reason, an encoder in the electric motor 208 may detect the movement and trigger a fault that disconnects the electric motor 208 from the charging port 212 using the contactors 210.

Referring now to the external supply mode for the system 200, the charging port 212 may be connected to an external device requiring AC power or DC power. In some implementations, an adaptor may be connected to the charging port 212 to configure the system 200 in the external supply mode. The adaptor may include data connections that provide signals indicating the power requirements of the external device. For example, the data connections may configure the system 200 to output 110V AC power, 220V AC power, or DC power from the charging port 212.

The switches SPST1, SPST2 may be open in the external supply mode, and the DC-to-DC converter 214 may be used to provide DC power to the high-voltage buses 234a, 234b. For example, power from the traction battery 202 may flow from the secondary side 214b of the DC-to-DC converter 214 to the primary side 214a. The tertiary side 214c may also receive power from the secondary side 214b in the external supply mode. The DC-to-DC converter 214 may alter the voltage from the traction battery 202 based on the voltage requirements of the external device. If the external load is requesting AC power, then the power electronics module 206 may invert the DC power to produce AC power for the external load. The sets of switches 240a, 240b, 240c may act as one leg of the inverter, and the set of switches 240d may act as the other leg of the inverter. Alternatively, if the external device is requesting DC power, then the power electronics module 206 may passively provide the DC power to the charging port 212 from the DC-to-DC converter 214 by closing switches M1, M3, M5, M8 and opening switches M2, M4, M6, M7, for example.

A further mode of the system 200 is a pre-charge mode that may utilize the DC-to-DC converter 214 to slowly and safely pre-charge the high-voltage buses 234a, 234b and the capacitor C5 to a desired voltage before the buses 234a, 234b are connected to a high-voltage source. For example, the pre-charging mode may be used before the switches SPST1, SPST2 are closed during every turn-on of the system 200 or before entering the inverter mode, the battery charging mode and/or the external supply mode. The pre-charge mode may use the DC-to-DC converter 214 to transfer battery power from the secondary side 214b to the primary side 214a to charge the high-voltage buses 234a, 234b. The duty cycle of the switches M11, M12 on the secondary side 214b and the switches M9, M10 on the primary side 214A may be modulated to control the current flowing to the buses 234a, 234b to avoid a surge of current. Pre-charging may be performed until a desired voltage is achieved across the buses 234a, 234b. After pre-charging the buses 234a, 234b is complete, the pre-charge mode may be exited in favor of the inverter mode, battery charging mode, or external supply mode, for example.

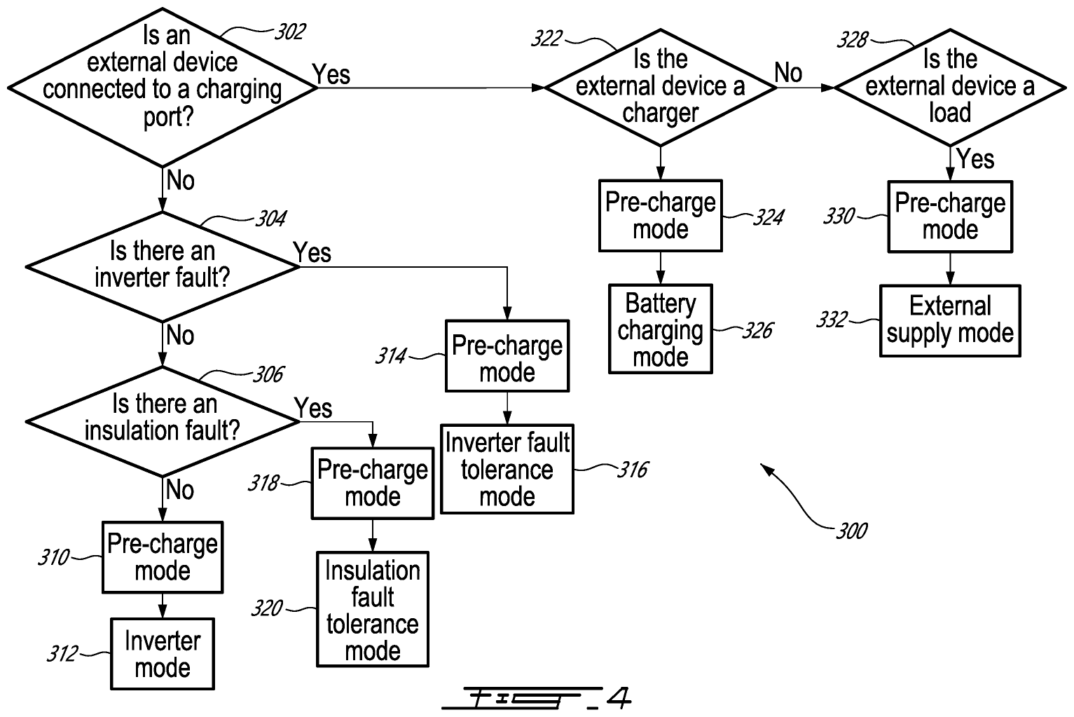

To further illustrate the various operating modes of the system 200, FIG. 4 provides a flow diagram illustrating a method 300 of selecting an operating mode from the multiple possible operating modes of the system 200, according to an embodiment. The method 300 will be described as being performed by the controllers 220 of the system 200. However, other controllers and/or systems may implement the method 300.

At block 302, the controllers 220 determine whether or not an external device is connected to the charging port 212. This determination may be made based on a position of a charging cap for the charging port 212. If the charging cap is open, then it may be determined that an external device is connected. Alternatively, if the charging port is closed, then it may be determined that an external device is not connected. The determination may also or instead be based on whether or not data signals from the external device are received at the charging port 212. If no external device is connected to the charging port 212, then the method 300 proceeds to block 304.

At block 304, the controllers 220 determine whether there is a fault at the power electronics module 206. An example of such a fault is one of the sets of electrical switches 240a, 240b, 240c being non-functional. Detecting a fault may be based on inputs from one or more sensors in the system 200, such as the current sensors X1-X3. If no current is detectable at one of the phase windings L5-L7, then it may be determined that a corresponding set of switches is non-functional. If no fault in the power electronics module 206 is detected, then the method 300 proceeds to block 306.

At block 306, the controllers 220 determine whether there is an insulation fault in the system 200. An insulation fault may be detected by an IMD. If no insulation fault is detected, then the method 300 may proceed to blocks 310, 312.

At optional block 310, the system 200 may enter the pre-charge mode to charge the high-voltage buses 234a, 234b and the capacitor C5. However, block 310 may be omitted if pre-charging is not required. Next, at block 312, the system 200 enters the inverter mode in which the electric motor 208 may be driven based on accelerator commands from an operator, for example.

Referring again to block 304, if a non-function set of switches is detected at the power electronics module 206, then method 300 may proceed to optional block 314 and to block 316. At block 314, the system 200 may enter the pre-charge mode as required. At block 316, the system 200 may enter the inverter fault tolerance mode to drive the electric motor 208 using two-phase operation.

If instead there is an insulation fault detected at block 306, then the method 300 may proceed to optional block 318 and to block 320. At block 318, the system 200 may enter the pre-charge mode. At block 320, the system 200 may enter the insulation fault tolerance mode to drive the electric motor 208 while galvanically isolating the traction battery 202.

Referring again to block 302, if the controllers 220 determine that there is an external device connected to the charging port 212, then the method 300 may proceed to block 322 where it is determined whether the external device is a charger, and/or proceed to block 328 where it is determined whether the external device is a load. The determination at blocks 322, 328 may be based on data signals received from the external device, for example.

If the external device is a charger, then the method 300 may proceed from block 322 to optional block 324 where the pre-charging mode may be entered, and then to block 326. At block 326, the system 200 enters the battery charging mode to charge the traction battery 202 from the charger.

If the external device is an external load, then the method 300 may proceed from block 328 to optional block 330 where the pre-charging mode may be entered, and then to block 332. At block 332, the system 200 enters the external supply mode where power from the traction battery 202 may be provided to the external load.

It should be noted the method 300 is only an example implementation of operating modes of the system 200. Other methods for selecting an operating mode for the system 200 are also contemplated. For example, in some embodiments, an operating mode may be selected based on user input through a user interface.

Various additional methods that may be performed by the system 200 will now be described.

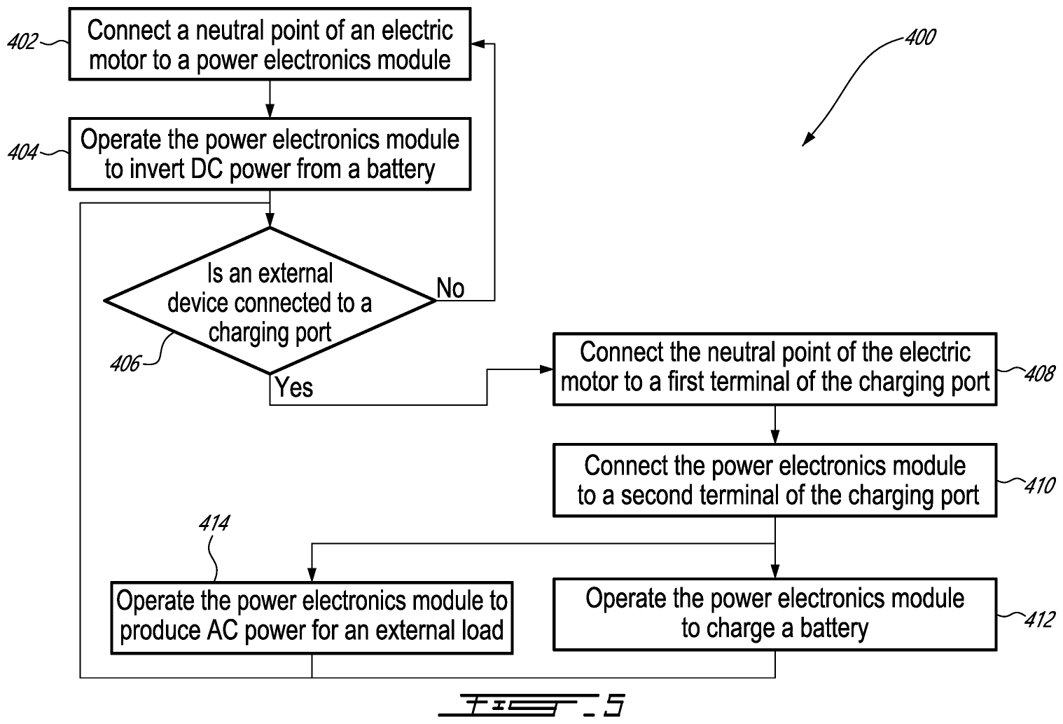

FIG. 5 is a flow diagram illustrating a method 400, according to an embodiment. The method 400 will be described as being performed by the system 200, but the method 400 may also be performed by other electronics systems for electric vehicles.

Block 402 includes connecting the neutral point 238 of the electric motor 208 to the power electronics module 206 to drive the electric motor 208, which may include connecting the neutral point 238 between the electrical switches M7, M8 using the contactors 210, as shown in FIG. 3. Optional block 404 then includes operating the power electronics module 206 to invert DC power from the traction battery 202 to produce AC power to drive the electric motor 208. For example, block 404 may be performed in response to accelerator signals from an accelerator of the electric vehicle.

Blocks 402, 404 may correspond to the inverter mode for the system 200, and might only be performed when an external device is disconnected from the charging port 212. In block 406, the system 200 determines whether an external device is connected to the charging port 212. Block 406 might be similar to block 302 of FIG. 4, for example. If an external device is not connected, then the method 400 may return to blocks 402, 404. The method 400 may cycle through blocks 402, 404, 406 to continuously check for external devices and, responsive to an external device being connected, proceed to blocks 408, 410.

Block 408 includes connecting the neutral point 238 of the electric motor 208 to the terminal 236a of the charging port 212, and block 410 includes connecting the power electronics module 206 to the terminal 236b of the charging port 212. For example, the set of switches 240d may be connected to the terminal 236b, and more particularly the terminal 236b may be between the electrical switches M7, M8, as shown in FIG. 3. It should be noted that the order of blocks 408, 410 in FIG. 5 is shown by way of example only. From blocks 408, 410, the method 400 may proceed to either block 412 or block 414 depending on the type of external device connected.

If the external device is a charger providing AC power, then the method 400 may proceed to block 412, which includes operating the power electronics module to rectify and boost the AC power to produce DC power to charge the traction battery 202. For example, the three sets of electrical switches 240a, 240b, 240c may be operated as at least part of a first leg of a rectifier and the fourth set of electrical switches 240d may be operated as at least part of a second leg of the rectifier. Block 412 may also include operating the DC-to-DC converter 214 to alter a voltage of the DC power to charge the traction battery 202, to reduce the voltage of the DC power to power the low-voltage systems 216, and/or galvanically isolate the traction battery 202 from the charging port 212, as discussed in further detail elsewhere herein. In this way, block 412 may correspond to the battery charging mode of the system 200. Block 412 may also include operating the DC-to-DC converter 214 to pre-charge the capacitor C5 using the traction battery 202 prior to charging the traction battery 202 (i.e., operating in the pre-charge mode of the system 200). Further, block 412 may include filtering electromagnetic interference using the EMI filter 230 integrated in the charging port 212.

If the external device is a load requesting power from the system 200, then the method 400 may proceed to block 414 from blocks 408, 410. Block 414 includes operating the power electronics module 206 to invert DC power from the traction battery 202 to produce AC power for the external load. For example, the three sets of electrical switches 240a, 240b, 240c may be operated as at least part of a first leg of an inverter and the fourth set of electrical switches 240d may be operated as at least part of a second leg of the inverter. Block 414 may further include operating the DC-to-DC converter 214 to alter a voltage of the DC power from the traction battery 202 for the external load.

Following blocks 412, 414, the method 400 may proceed back to block 406 to check if the external device is still connected to the charging port 212. Responsive to the external device being disconnected from the charging port 212, the method 400 may proceed back to blocks 402, 404 to reconnect the neutral point 238 of the electric motor 208 to the power electronics module 206.

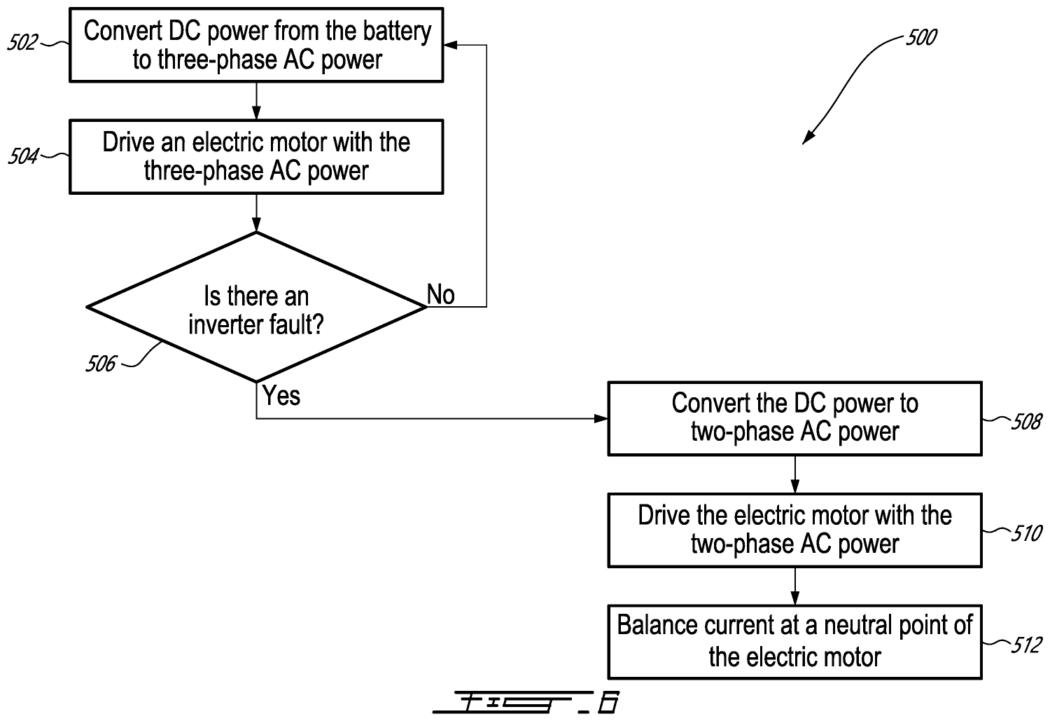

FIG. 6 is another flow diagram illustrating a method 500, according to an embodiment. The method 500 will be described as being performed by the system 200, but the method 500 may also be performed by other electronics systems for electric vehicles.

At block 502, the system 200 may convert DC power from the traction battery 202 to three-phase AC power using the three sets of electrical switches 240a, 240b, 240c in the power electronics module 206. The fourth set of switches 240d may be inactive when converting the DC power from the traction battery 202 to three-phase AC power. Block 504 then includes driving the electric motor 208 with the three-phase AC power. Blocks 502, 504 may correspond to the inverter mode of the system 200.

Block 506 includes determining if there is a fault at the power electronics module 206, which may include one of the sets of electrical switches 240a, 240b, 240c being non-functional. In some implementations, block 506 may include measuring current at each of the phase windings L5-L7 (e.g., using the current sensors X1-X3) to determine if the sets of electrical switches 240a, 240b, 240c are operating correctly. If no fault is detected, then the method 500 may return to blocks 502, 504. Block 506 may be performed cyclically to check for faults. While blocks 502, 504 are shown sequentially in FIG. 6, it is noted that these blocks may be performed simultaneously in some implementations.

Responsive one of the three sets of electrical switches 240a, 240b, 240c being non-functional at block 506, the method 500 may proceed to blocks 508, 510, 512. Block 508 includes converting the DC power from the traction battery to two-phase AC power using the remaining two sets of electrical switches, and block 510 includes driving the electric motor 208 with the two-phase AC power. Block 512 includes balancing current at the neutral point 238 of the electric motor 208 using the fourth set of electrical switches 240d in the power electronics module 206. For example, the fourth set of electrical switches 240d may be operated to provide a current path from the neutral point 238 to the traction battery 206, which may include operating (e.g., switching) the switches M7, M8 to provide a current path from the neutral point 238 to high-voltage buses 234a, 234b based on the polarity of current at the neutral point 238. Blocks 508, 510, 512 may correspond to the inverter fault tolerant mode of the system 200. While blocks 508, 510, 512 are shown sequentially in FIG. 6, it is noted that these blocks may be performed simultaneously. For example, converting the DC power to two-phase AC power, driving the electric motor 208 and balancing current at the neutral point 238 may be performed continuously in the fault tolerant mode, responsive to an accelerator signal from an operator.

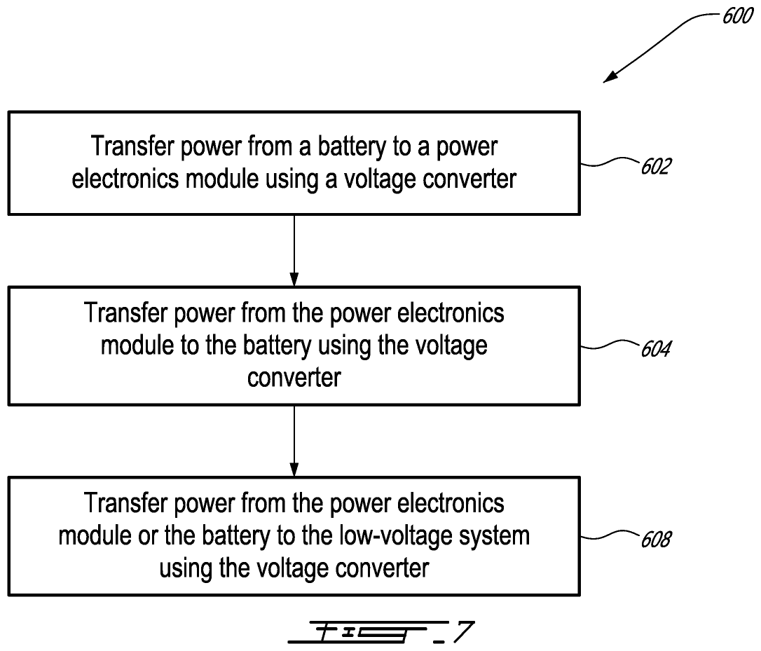

FIG. 7 is a further flow diagram illustrating a method 600, according to an embodiment. The method 600 will be described as being performed by the system 200, but the method 600 may also be performed by other electronics systems for electric vehicles.

Block 602 includes transferring power from the traction battery 204 to the power electronics module 206 using the DC-to-DC converter 214 or, more generally, any form of voltage converter. Block 602 may correspond to the pre-charge mode, the external supply mode and the insulation fault tolerant mode of the system 200. In some implementations, block 602 includes inverting, using the secondary side 214b, a first DC power from the traction battery 202 to produce AC power at the transformer T2 and rectifying, using the primary side 214a, the AC power from the transformer T2 to provide a second DC power for the power electronics module 206. The voltage of the second DC power may be greater than or less than the voltage of the first DC power. For example, if the charging port 212 is connected to an external load, then a duty cycle of the electrical switches M9, M10 at the primary side 214a and/or a duty cycle of the electrical switches M11, M12 at the secondary side 214b may be adjusted based on a voltage requirement of the external load. This may buck or boost the voltage from the traction battery 202 to match the voltage requirement of the external load.

Block 604 includes transferring power from the power electronics module 206 to the traction battery 204 using the DC-to-DC converter 214, which may occur during the battery charging mode of the system 200. Block 604 may include inverting, using the primary side 214a, a first DC power from the power electronics module 206 to produce AC power at the transformer T2 and rectifying, using the secondary side 214b, the AC power from the transformer T2 to provide a second DC power to charge the traction battery 202. A duty cycle of the electrical switches M9, M10 at the primary side 214a and/or a duty cycle of the electrical switches M11, M12 at the secondary side 214b may be adjusted to control the voltage of the second DC power based on a voltage needed to charge the traction battery 202.

Block 608 includes transferring power from the power electronics module 206 or the traction battery 202 to the low-voltage systems 216 using the DC-to-DC converter 214. Block 608 may occur during any, one, some or all operational modes of the system 200. Block 608 may include inverting a first DC power from the power electronics module 206 to produce AC power at the transformer T2 using the primary side 214a, or inverting a first DC power from the traction battery 202 to produce the AC power at the transformer T2 using the secondary side 214b. The AC power from the transformer T2 may be rectified by the tertiary side 214c to provide a second DC power to power the low-voltage systems. The DC-to-DC converter 214 may reduce the voltage at the primary side 214a or the secondary 214b for the low-voltage systems 216. Further, the DC regulator 232 may regulate a voltage of the second DC power for the low-voltage systems 216.

The methods 400, 500, 600 are shown by way of example only. Other methods may also be performed by the system 200. It should also be noted that any two or more of the methods 400, 500, 600 may be implemented in conjunction by the system 200.

Systems and methods of charging multiple electric vehicles from a single EVSE will now be provided. Such systems and methods may be useful where the demand for EVSEs exceeds the number available.

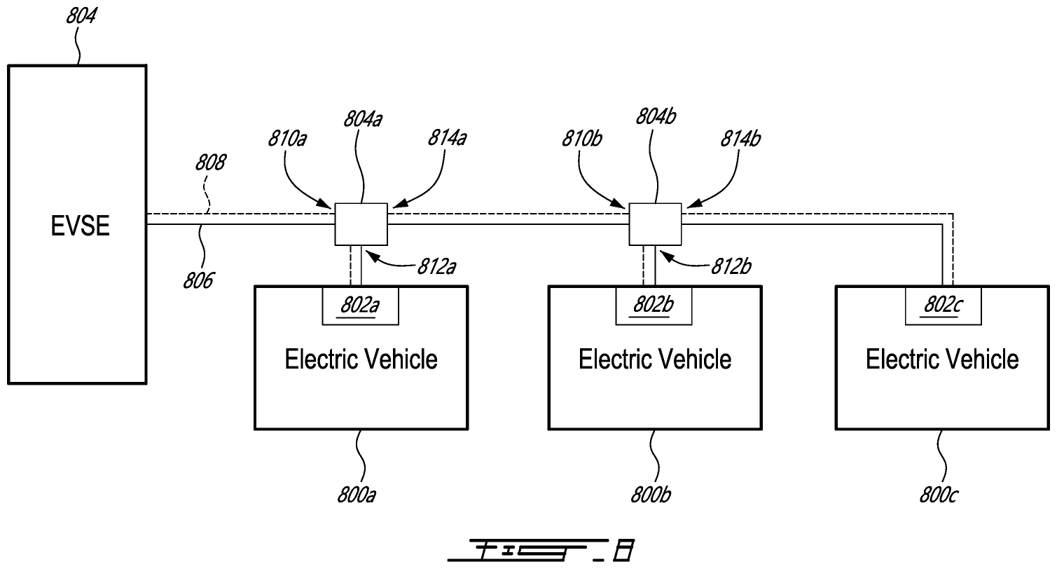

FIG. 8 is a block diagram illustrating multiple electric vehicles 800a, 800b, 800c connected to and being charged by a single EVSE 804, according to an embodiment. As is described in detail below, FIG. 8 illustrates an example of “daisy-chain” charging multiple electric vehicles from a single source of power. Daisy-chain charging may be implemented to allow each of the electric vehicles 800a, 800b, 800c to connect the EVSE 804 at once. Each of the electric vehicles 800a, 800b, 800c may then be charged simultaneously and/or sequentially. This may avoid operators having to monitor the charge state of the electric vehicles 800a, 800b, 800c and manually switch the EVSE 804 between the electric vehicles 800a, 800b, 800c as charging is completed. Daisy-chain charging may be particularly useful in the case that the multiple electric vehicles 800a, 800b, 800c need to be charged overnight from a single EVSE.

Any one or more of the electric vehicles 800a, 800b, 800c may be similar to the electric snowmobile 100 of FIGS. 1A-1C, but other embodiments of electric vehicles are also contemplated. Each of the electric vehicles 800a, 800b, 800c includes a respective charging port 802a, 802b, 802c, which may be similar to the charging port 212 in the system 200 and/or may include a standardized charging connector such as a J1772 connector, a combined charging system (CCS) connector, and/or North American charging standard (NACS) connector, for example. Each of the charging ports 802a, 802b, 802c is connected to the EVSE 804 to receive electrical power from the EVSE 804.

The EVSE 804 has a power output 806 for charging the electric vehicles 800a, 800b, 800c. The power output 806 may include an electrical cable with a connector (or plug) at one end for connecting to a charging port of an electric vehicle. In some implementations, the EVSE 804 may enable level 1, level 2 and/or level 3 (DC fast) charging through the power output 806. For example, the power connection may include the live, neutral and ground connections for level 1 and level 2 charging, and/or include positive and negative DC connections for level 3 charging. Although only one power output 806 is shown in FIG. 8, the EVSE 804 may more generally include multiple power outputs.

In addition to the power output 806, the EVSE 804 also has a data connection 808 for communicating with an electrical vehicle to facilitate charging. For example, the data connection 808 may indicate to the EVSE 804 that the power output 806 is connected to an electric vehicle and also indicate the charging parameters. The power output 806 and data connection 808 may be provided within a single cable from the EVSE 804 and connect to electrical vehicles using a single connector.

As shown, the power output 806 and data connection 808 from the EVSE 804 may be connected to each of the electric vehicles 800a, 800b, 800c using two charging adaptors 804a, 804b. The adaptors 804a, 804b may each be a form of electrical splitter that splits the power output 806 and data connection 808 to the three electric vehicles 800a, 800b, 800c such that each of the electric vehicles 800a, 800b, 800c may be charged by the EVSE 804.

The adaptor 804a includes three ports 810a, 812a, 814a. The port 810a may function as an input port that receives power from the power output 806 of the EVSE 804. The received power may then be provided to either or both of the ports 812a, 814a. The port 812a is connected to the charging port 802a of the electric vehicles 800a, which may allow the electrical vehicle 800a to be charged from the power output 806. The port 814a is connected to the other adaptor 804b to transfer power to the other electric vehicles 800b, 800c.

Similar to the adaptor 804a, the adaptor 804a also includes three ports 810b, 812b, 814c. The port 810b is connected to the port 814a of the adaptor 804a, allowing power to be received from the power output 806. The adaptor 804b may then distribute the power to the charging port 802b of electric vehicle 800b via the port 812b, and/or to the charging port 802c of electric vehicle 800c via the port 814b. In this way, the adaptors 804a, 804b may split the power output 806 to each of the electric vehicles 800a, 800b, 800c. For example, each of the charging ports 802a, 802b, 802c may be connected in parallel to the power output 806.

The adaptors 804a, 804b may also split the data connection 808 to each of the electric vehicles 800a, 800b, 800c. For example, the port 810a may include a terminal to connect to the data connection 808, and each of the other ports 812a, 814a, 810b, 812b, 814b may also include data terminals to form data connections between the adaptors 804a, 804b and the electric vehicles 800a, 800b, 800c. These data connections may enable each of the adaptors 804a, 804b and/or the electric vehicles 800a, 800b, 800c to communicate with each other and/or with the EVSE 804 to facilitate charging. For example, each of the charging ports 802a, 802b, 802c may be connected in series to the data connection 808. In some cases, communications along the data connection 808 may inform the EVSE 804 and the electric vehicles 800a, 800b, 800c that they are in a daisy-chain configuration.

Cables may be used to interconnect the adaptors 804a, 804b and the electric vehicles 800a, 800b, 800c for the power output 806 and the data connection 808. One or more of these cables may be part of the adaptors 804a, 804b, or may be separate cables that attach to the ports of the adaptors 804a, 804b.

Various methodologies may be implemented to charge the electric vehicles 800a, 800b, 800c when connected to the EVSE 804 via the adaptors 804a, 804b, as shown in FIG. 8. In some implementations, the electric vehicles 800a, 800b, 800c may be charged sequentially. The sequence of charging may be selected based on the order that the electric vehicles 800a, 800b, 800c are connected to the EVSE 804. For example, the electric vehicle 800c may be charged first as it is the last vehicle in the row, followed by electrical vehicle 800b and then electric vehicle 8020a. Alternatively, the order of charging may be selected by a user using interfaces on the EVSE 804, the adaptors 804a, 804b and/or the electric vehicles 800a, 800b, 800c.

In other implementations, all three of the electric vehicles 800a, 800b, 800c may be charged simultaneously by the EVSE 804 by splitting the power from the power output 806 to each of the charging ports 802a, 802b, 802c. The power in the power output 806 may be split evenly between each of the electric vehicles 800a, 800b, 800c. However, the power need not be split evenly in all implementations. For example, the power to each of the electric vehicles 800a, 800b, 800c may be adjusted based on the SOC of each vehicle such that the electric vehicles 800a, 800b, 800c complete charging at similar times.

The charging and power distribution to the electric vehicles 800a, 800b, 800c from the power output 806 may be controlled in any of a number of different ways. In some implementations, the adaptors 804a, 804b do not actively control charging and passively distribute power to each of the charging ports 802a, 802b, 802c. As such, voltage from the power output 806 may be present at each of the charging ports 802a, 802b, 802c. The electric vehicles 800a, 800b, 800c themselves may then implement a defined methodology for daisy-chain charging. For example, if the electric vehicles 800a, 800b, 800c are to be charged sequentially starting with the electric vehicle 800c, then the electrical vehicle 800c may implement charging while the electric vehicles 800a, 800b may prevent charging until it is their turn.

Alternatively or additionally, the adaptors 804a, 804b may actively deliver power only to the one or more electric vehicles that are scheduled to be charged, and may also control the power delivered to each of the electric vehicles. In some embodiments, the adaptors 804a, 804b include controllers, power converters and/or switches to control charging. These controllers may include one or more processors and memory storing computer-readable instructions executable by the processors. Examples of processors and memory are provided elsewhere herein.

It should be noted that FIG. 8 is provided by way of example only, and other implementations of charging multiple electric vehicles from the EVSE 804 are also contemplated. For example, more or fewer than three electric vehicles may be connected to the EVSE 804 as needed. More or fewer adaptors may be implemented in response to electric vehicles being connected or disconnected from the EVSE 804. Further, the adaptors 804a, 804b need not be limited to three ports, and may include additional ports to connect to other adaptors and/or electric vehicles.

The embodiments described in this document provide non-limiting examples of possible implementations of the present technology. Upon review of the present disclosure, a person of ordinary skill in the art will recognize that changes may be made to the embodiments described herein without departing from the scope of the present technology.

What is claimed is:

1. A system for an electric vehicle, the system comprising:
a battery;
a power electronics module to connect to the battery;
an electric motor comprising a plurality of phase windings and a neutral point, each of the plurality of phase windings connected between the power electronics module and the neutral point;
a port to connect to an external device, the port comprising a first terminal and a second terminal; and
at least one electrical switch to selectively connect the first terminal of the port to the neutral point of the electric motor and to selectively connect the second terminal of the port to the power electronics module.

2. The system of claim 1, wherein the at least one electrical switch is to connect the first terminal of the port to the neutral point of the electric motor and to connect the second terminal of the port to the power electronics module when the port is connected to the external device.

3. The system of claim 2, wherein:
the external device comprises a charger providing alternating current (AC) power; and
the electric motor and the power electronics module are to rectify and boost the AC power to charge the battery.

4. The system of claim 2, wherein:
the external device comprises an external load; and
the port is to transfer power from the battery to the external load.

5. The system of claim 4, wherein the power electronics module is to invert direct current (DC) power from the battery to produce alternating current (AC) power for the external load.

6. The system of claim 2, wherein the at least one electrical switch is to disconnect the first terminal of the port from the neutral point of the electric motor and to disconnect the second terminal of the port from the power electronics module when the port is disconnected from the external device.

7. The system of claim 6, wherein the at least one electrical switch is to connect the neutral point of the electric motor to the power electronics module when the port is disconnected from the external device.

8. The system of claim 6, wherein when the port is disconnected from the external device, the power electronics module is to invert direct current (DC) power from the battery to produce alternating current (AC) power to drive the electric motor.

9. The system of claim 1, wherein:
the plurality of phase windings comprises three phase windings;
the power electronics module comprises three sets of electrical switches connected to three phase windings, respectively; and
the power electronics module further comprises a fourth set of electric switches to connect to the second terminal the port.

10. The system of claim 9, wherein:
the system comprises a first bus and a second bus connecting the battery to the power electronics module;
the fourth set of electrical switches comprises a first electrical switch and a second electrical switch connected in series between the first bus and the second bus; and
the at least one switch is to connect the second terminal of the port between the first electrical switch and the second electrical switch of the fourth set of electrical switches.

11. A system for an electric vehicle, the system comprising:
an electric motor comprising three phase windings connected to a neutral point;
a power electronics module comprising three sets of electrical switches connected to the three phase windings, respectively, and a fourth set of electrical switches to connect to the neutral point;
a battery to connect to the power electronics module; and
a port to connect to the neutral point and to the fourth set of switches.

12. The system of claim 11, wherein the three sets of electrical switches are to convert direct current (DC) power from the battery to alternating current (AC) power to drive the electric motor.

13. The system of claim 12, wherein when the three sets of electrical switches are converting DC power from the battery to AC power to drive the electric motor, the port is disconnected from the neutral point and disconnected from the fourth set of electrical switches.

14. The system of claim 12, wherein when the three sets of electrical switches are converting DC power from the battery to AC power to drive the electric motor, the fourth set of electrical switches is inactive.

15. The system of claim 11, wherein when the three sets of electrical switches comprise a non-functional set of switches, the remaining two sets of electrical switches are to convert DC power from the battery to AC power to drive the electric motor.

16. A method for an electric vehicle comprising an electric motor, a power electronics module, and a port, the method comprising:
connecting a neutral point of the electric motor to the power electronics module to drive the electric motor; and
responsive to an external device being connected to the port:
connecting the neutral point of the electric motor to a first terminal of the port, and
connecting the power electronics module to a second terminal of the port.

17. The method of claim 16, wherein the external device comprises a charger providing alternating current (AC) power, the method comprising:
operating the power electronics module to rectify and boost the AC power to produce direct current (DC) power to charge a battery of the electric vehicle.

18. The method of claim 16, wherein the external device comprises an external load, the method comprising:
operating the power electronics module to invert direct current (DC) power from a battery of the electric vehicle to produce alternating current (AC) power for the external load.

19. The method of claim 16, comprising:
responsive to the external device being disconnected from the port, reconnecting the neutral point of the electric motor to the power electronics module.

20. The method of claim 16, comprising:
operating the power electronics module to invert direct current (DC) power from a battery of the electric vehicle to produce alternating current (AC) power to drive the electric motor when the external device is disconnected from the port.
